(19) United States
(12) Patent Application Publication
(10) Pub. No.: US 2013/0302470 A1
(43) Pub. Date: Nov. 14, 2013

(54) L-amino-acid-containing feed additive in the form of fermentation-broth-based granules, and processes for its preparation

(71) Applicant: EVONIK INDUSTRIES AG, ESSEN (DE)

(72) Inventors: Franz Ulrich Becker, Freigericht-Horbach (DE); Ken O'Halloran, Frankfurt (DE); Christoph Kobler, Alzenau (DE); Ansgar Oelmann, Gelnhausen (DE); Thomas Häussner, Eppertshausen (DE)

(21) Appl. No.: 13/890,268

(22) Filed: May 9, 2013

(30) Foreign Application Priority Data
May 9, 2012 (EP) 12167236.4

(51) Int. Cl. A23K 1/16; A23K 1/18

(52) U.S. Cl. CPC A23K 1/1634; A23K 1/188
USPC 426/7; 426/99; 426/61

(57) ABSTRACT

The invention relates to a granular fermentation-broth-based feed additive, comprising an L-amino acid selected from the group consisting of L-lysine, L-methionine, L-threonine, L-tryptophan, L-valine or mixtures of these, suitable for the preparation of feeds for animals kept in aquaculture, where the content of the L-amino acid or the mixtures thereof amount to 20% by weight of the total composition of the granular feed additive; where at least 70% by weight of the particles have a particle diameter of from >63 μm to <300 μm, where the biomass content amounts to ≧5% by weight and where the surface of the particles is fully or partially coated with an edible oil, wherein the L-amino acid is L-lysine, is present as a sulphate salt and the molar ratio of sulphate to L-lysine amounts to at least 0.5.

### CROSS REFERENCE TO RELATED APPLICATIONS

The present application claims priority to European Application, EP 12167236.4, filed on May 9, 2012, the contents of which is incorporated herein by reference in its entirety.

### FIELD OF THE INVENTION

The invention relates to an L-amino-acid-comprising feed additive in the form of fermentation-broth-based granules and processes for its preparation, wherein the L-amino acid is selected from the group consisting of L-lysine, L-methionine, L-threonine, L-tryptophan, L-valine, in particular L-lysine.

### BACKGROUND OF THE INVENTION

Animal feeds are supplemented with individual amino acids to meet the animals' needs. The substance which is currently predominantly employed for supplementing animal feeds for example with L-lysine is L-lysine monohydrochloride, with an L-lysine content of approximately 80%. Since L-lysine is produced fermentatively, it must, to prepare the monohydrochloride, first and foremost be separated in complicated process steps from all remaining constituents of the crude fermentation broth, then converted into the monohydrochloride, and the latter must be crystallized. This generates a large number of by-products and the reagents required for processing in the form of waste. Since high purity of the animal feed supplement is not always required and since, moreover, the fermentation by-products still frequently contain nutritionally effective substances of value, there has, therefore, been no lack of attempts in the past to avoid the complicated production of feed amino acids, in particular of pure L-lysine monohydrochloride, and to convert the crude fermentation broth into a solid animal feed in a more cost-effective manner.

It has emerged that the grave disadvantage is the complex composition of such media, because these media can in general only be dried with difficulty, whereupon they are hygroscopic, virtually not flowable, at risk from agglomeration, and not suited to the technically complex processing in feed mills. This applies in particular to L-lysine-containing fermentation products. Simple dehydration of the crude fermentation broth by spray-drying resulted in a dusty, highly hygroscopic concentrate which agglomerated after a brief storage period and which cannot be employed as animal feed in this form.

EP 0 533 039 relates to processes for the preparation of a fermentation-broth-based amino acid animal feed supplement, where the supplement can be obtained directly from the fermentation liquor by means of spray-drying. In one variant, some of the biomass is, to this end, removed before the spray-drying step. Indeed, if the fermentation is conducted in a very clean manner, i.e. when a fermentation broth with a low residual content of organic substances is obtained, the broth may be dried even without the biomass and without additional carrier adjuvant to give granules which may be handled with ease.

GB 1 439 121 discloses solid concentrates which contain approximately 20% by weight of L-lysine, and this specification also describes L-lysine-containing fermentation broths with a pH of 4.5 and the addition of sodium bisulphite.

EP 0 615 693 discloses a process for the preparation of a fermentation-broth-based animal feed additive in which the fermentation broth, if appropriate after removal of some of the constituents, is spray-dried to give fine particles of which at least 70% by weight have a maximum particle size of 100 μm and these fine particles are, in a second step, enlarged to give granules which contain the fine particles at not less than 30% by weight.

According to GB 1 439 728, an L-lysine-containing concentrate is prepared from a fermentation broth which, before concentration, is acidified with HCl to a pH of approximately 6.4 and to which bisulphite is added for stabilization purposes. After the evaporation, the product is acidified further to a pH of 4.0, and the desired product is obtained by spray-drying.

EP-A 1 331 220 relates to granulated feed additives which contain L-lysine as the main component. In that specification, it has been found that the amount of the counterions for the lysine, such as, for example, the amount of the sulphate ions, may be reduced by using hydrogen carbonate and/or carbonate, which are generated during the fermentation, as the counterion. In total, an anion/lysine ratio of from 0.68 to 0.95 is claimed.

It is said that reducing the counterions such as, for example, sulphate in the L-lysine-containing product results in an improvement of the hygroscopic properties and the caking tendency.

WO 2007/141111 discloses a process for the preparation of an L-lysine-containing feed additive, comprising the steps of fermenting an L-lysine-producing coryneform bacterium, followed by the addition of ammonium sulphate, lowering the pH by adding sulphuric acid to 4.9 to 5.2, where a total sulphate/L-lysine ratio of from 0.85 to 1.2 in the broth is established, concentration and drying, preferably granulation, to give a product with an L-lysine content of from 10 to 70% by weight as lysine base, based on the total amount. The particle sizes of this product, however, are in the range of from ≧300 μm to ≦1800 μm, and are therefore too large for use as feed additives for aquatic animals.

### OBJECT OF THE INVENTION

It is an object of the invention to provide an L-amino acid-, in particular L-lysine-sulphate-, containing feed additive in the form of fermentation-broth-based granules, which is suitable for preparing feeds for animals kept in aquaculture, such as, for example, fish and crustaceans.

### SUMMARY OF THE INVENTION

The object is achieved by a granular fermentation-broth-based feed additive, comprising an L-amino acid selected from the group consisting of L-lysine, L-methionine, L-threonine, L-tryptophan, L-valine or mixtures of these, suitable for the preparation of feeds for animals kept in aquaculture, where the content of the L-amino acid or the mixtures thereof amount to 20% by weight of the total composition of the granular feed additive; where at least 70% by weight of the particles have a particle diameter of from >63 μm to <300 μm, where the biomass content amounts to ≧5% by weight and where the surface of the particles is fully or partially coated with an edible oil.

Surprisingly, it has been found that the L-amino acid present in the granular feed additive, where the amino acid is selected from the group consisting of L-lysine, L-methionine, L-threonine, L-tryptophan, L-valine or mixtures thereof, in particular L-lysine sulphate, in the granular product of the present invention even at a lower particle size of from >63 μm to <300 μm has a better hydrothermal stability, better homogeneity in compound feeds and better leaching properties than conventional granules.

In a preferred embodiment, the L-amino acid is L-lysine and is present as a sulphate salt, with the molar ratio of sulphate to L-lysine amounting to at least 0.5, preferably 0.6, 0.8, 0.9, 0.95, 1.0, 1.05, 1.1, 1.2 (on a molar basis).

The molar sulphate/L-lysine ratio V is calculated using the formula: V=2×[SO₄²⁻]/[L-lysine].

In a further preferred embodiment, the biomass is derived from the genus Corynebacterium or the genus Escherichia.

It is furthermore preferred that the content of the abovementioned L-amino acid or the abovementioned mixtures thereof amounts to ≧30, 40, 50, 60% by weight of the total composition based on the feed additive.

It is particularly preferred that the content of L-lysine sulphate amounts to ≧30, 40, 50, 60% by weight of the total composition, based on the feed additive.

It is particularly preferred that at least 70, 75, 80, 85, 90, 95, 97% by weight of the particles have a particle size diameter of from >63 μm to <300 μm.

In a further particularly preferred embodiment, at least 70, 75, 80, 85, 90, 95, 97% by weight of the particles have a particle size diameter of from >63 μm to <280 μm.

In a further particularly preferred embodiment, at least 70, 75, 80, 85, 90, 95, 97% by weight of the particles have a particle size diameter of from >63 μm to <200 μm.

In a further particularly preferred embodiment, at least 70, 75, 80, 85, 90, 95, 97% by weight of the particles have a particle size diameter of from >63 μm to <300 μm, with at least 3% by weight of the particles having a particle size diameter of from >63 μm to <100 μm.

In a further particularly preferred embodiment, at least 70, 75, 80, 85, 90, 95, 97% by weight of the particles have a particle size diameter of from >63 μm to <300 μm, with at least 5% by weight of the particles having a particle size diameter of from >63 μm to <100 μm.

In a further particularly preferred embodiment, at least 70, 75, 80, 85, 90, 95, 97% by weight of the particles have a particle size diameter of from >63 μm to <300 μm, with at least 10% by weight of the particles having a particle size diameter of from >63 μm to <100 μm.

In a further particularly preferred embodiment, at least 70, 75, 80, 85, 90, 95, 97% by weight of the particles have a particle size diameter of from >63 μm to <300 μm, with at least 15% by weight of the particles having a particle size diameter of from >63 μm to <100 μm.

In a further preferred embodiment, the particles with a particle size diameter of <63 μm account for 25% by weight or less, 15% by weight or less, 10% by weight or less, 5% by weight or less, 3% by weight or less, 2% by weight, 0 to 1% by weight, 0.5% by weight or less.

The bulk density of the granular feed additive preferably amounts to 500 to 650 g/l, especially preferably 530 to 570 g/l.

In a further preferred embodiment, the biomass content amounts to ≧10, 20, 30, 40, 50, 60, 70, 80, 90% by weight.

The edible oil is preferably selected from vegetable oil, in particular soybean oil, olive oil, sunflower seed oil, animal oil or fat or oil produced fermentatively by microorganisms.

The expression “edible oil” in the context of the present invention means a consumable oil, i.e. an oil which can be utilized when digested by humans and animals. Edible oils are compositions which are essentially composed of, or contain, triglycerides, with the triglyceride content preferably amounting to at least 80, 85, 90, 95% by weight. It is furthermore preferred that the edible oil accounts for from 0.01 to 2% by weight of the total composition.

The particle size distribution is measured by screening analysis in a Hosokawa Alpine air-jet screening apparatus, type 200 LS-N, screening set: mesh sizes 20, 32, 45, 63, 100, 150, 200, 250, 280, 300, 400, 500, 600, 630, 710, 800, 1000, 1180, 1400, 1600 and 2000 μm; (DIN ISO 3310); screening time: 3 min; where 25 g of the test granules are screened with the screen with the greatest degree of fineness (20 μm), i.e. with the finest screen, and where the fraction of the granular material which is retained by the screen is applied to the screen with the next-bigger mesh size and the process is repeated up to the screen with the coarsest fineness (2000 μm) of the screening set:

The percentage proportion per screen fraction is calculated as follows:

Fraction=undersize (g)×100/W (g) [%]

W—initial sample weight in g

The screening analysis therefore describes the percentage of the individual screen fractions (0-20 μm/20-32 μm/32-45 μm etc.) based on the initial amount (25 g=100%)

In air-jet screen analysis, in principle, the finest screen is the starting point. A defined amount of the granular sample material is applied and screened. The amount remaining on the screen in question is weighed together with the screen, and then the weight of the “clean” screen without sample material is subtracted from this figure. This gives the residue on the screen in g.

To calculate the undersize (proportion of the particles smaller than the screen being used), in the case of the smallest fraction (e.g. 20 μm), the figure is subtracted from the initial mass of the residue on screen—20 μm.

In the case of the further fractions (e.g. 20-32 μm), the undersize (in g) is calculated by subtracting the residue on the larger screen (in this case: 63 μm screen) from the residue on the smaller screen (in this case: 32 μm screen).

The present invention also provides a process for the preparation of the abovementioned feed additive, comprising the following steps:
a) fermentation of an L-amino-acid-producing microorganism, preferably a coryneform bacterium or bacteria of the genus Escherichia, in an aqueous nutrient medium under aerobic conditions, wherein the L-amino acid is selected from the group consisting of L-lysine, L-methionine, L-threonine, L-tryptophan, L-valine;
b) concentration of the fermentation broth by evaporation;
c) in the event that the L-amino acid is L-lysine: addition of ammonium sulphate and/or sulphuric acid, wherein a sulphate/L-lysine ratio of from 0.85 to 1.2 in the broth is established;
d) removal of the water from the mixture and drying to give granules;
e) adjusting the particle size to give a product which contains at least 70% by weight of particles with a particle size of from >63 μm to <300 μm, preferably >63 μm to <280 μm;
f) coating the particles of step d) and/or e) with an edible oil to give particles which are fully or partially coated by the edible oil.

In a preferred process, the particle size is adjusted in step e) by grinding, screening, grading or other suitable methods.

The feed additive of the present invention is used for the preparation of feeds for animals kept in aquaculture.

According to the present invention, the additive according to the present invention is used in feeds for feeding animals kept in aquaculture.

The invention therefore also embraces a feed, more particularly a fish feed, comprising the granular feed additive in accordance with the present invention in an amount of from 0.01 to 5.0% by weight, preferably from 0.05 to 0.95% by weight, based on the total feed composition. The invention preferably also embraces a feed, more particularly a fish feed, comprising an L-lysine-containing granular feed additive according to the present invention in an amount of from 0.01 to 5.0% by weight, preferably from 0.05 to 0.95% by weight, based on the total feed composition.

The animals kept in aquaculture are preferably fish, crustaceans, in particular shrimps/prawns. In a preferred use, the animals kept in aquaculture are freshwater and saltwater fish and crustaceans selected from the group consisting of carps, trouts, salmons, catfish, perches, flat fish, sturgeons, tunas, eels, breams, codfish, shrimps and prawns, very especially silver carp (Hypophthalmichthys molitrix), grass carp (Ctenopharyngodon idella), common carp (Cyprinus carpio) and bighead carp (Aristichthys nobilis), crucian carp (Carassius carassius), catla (Catla Catla), rohi (Labeo rohita), Pacific salmon and Atlantic salmon (Oncorhynchus kisutch and Salmo salar), rainbow trout (Oncorhynchus mykiss), channel catfish (Ictalurus punctatus), African sharptooth catfish (Clarias gariepinus), pangasius (Pangasius bocourti and Pangasius hypothalamus), Nile tilapia (Oreochromis niloticus), milk fish (Chanos chanos), ling (Rachycentron canadum), whiteleg shrimp (Litopenaeus vannamei), black tiger shrimp (Penaeus monodon) and giant river prawn (Macrobrachium rosenbergii).

Furthermore, it is preferred that the feed contains the granular feed additive according to the present invention in an amount which is from 0.01 to 5.0% by weight, preferably 0.05 to 0.95% by weight, L-amino acid, based on the total feed composition, wherein the L-amino acid is selected from the group consisting of L-lysine, L-methionine, L-threonine, L-tryptophan, L-valine or mixtures thereof.

Especially preferred in this context is that the feed contains the granular feed additive according to the present invention in an amount which is from 0.01 to 5.0% by weight, preferably 0.05 to 0.95% by weight, L-lysine, preferably L-lysine sulphate, based on the total feed composition (calculated as lysine-base).

It should be pointed out that the size of the feed particles depends on the species and the lifecycle stage of the animal to be fed. Thus, for salmon or trout there are up to 8 different feed sizes, starting from what is known as “crumble feed” for very small fish (1-2 cm) up to feed extrudates 0.8-1.2 cm in diameter. In the case of feeds for shrimps/prawns (whiteleg shrimp (Litopenaeus vannamei), black tiger shrimp (Penaeus monodon) and giant river prawn, (Macrobrachium rosenbergii)), the diameter of the feed particle is from 0.1 to 0.3 cm in the middle and final growth phase (pelleted or extruded), and the length is approximately 0.2 to not more than 1 cm. In the case of feeds for carp, the diameter of the feed particle is from 0.3 to 0.6 cm (pelleted only), and the length is approximately 1 to 2 cm. In the case of feeds for tilapias, the diameter of the feed particles (pelleted, “sinking feed”) is from 0.2 to 0.5 cm and the length approximately 0.5 to 1 cm or diameter 0.3 to 0.6 cm and length 0.3 to 0.6 cm (extruded, “floating feed”).

The particle size distribution of the granular feed additive according to the invention is right for each of these applications. The granular feed additive of the invention can be used with particular preference in feeds in which the homogeneity of the feed additives in the feed has a particular part to play, such as, for example, in the case of small feed sizes or early growth phases of fish (fingerling breeding).

The granular feed additive according to the present invention preferably has one of the properties 1-200 or 1a-200a mentioned hereinbelow:

| | | | L-Amino acid* | |
|---|---|---|---|---|
| | | | content, in | |
| | | | particular | |
| | | Particle | L-lysine | |
| | | size | sulphate | Biomass** |
| | Particle size | content ≧ | content ≧ | content ≧ |
| | [μm] | [% by wt.] | [% by wt.] | [% by wt.] |
| 1 | >63 to <300 | 70 | 20 | 5 |
| 2 | >63 to <300 | 70 | 20 | 10 |
| 3 | >63 to <300 | 70 | 20 | 20 |
| 4 | >63 to <300 | 70 | 20 | 30 |
| 5 | >63 to <300 | 70 | 20 | 40 |
| 6 | >63 to <300 | 70 | 20 | 50 |
| 7 | >63 to <300 | 70 | 20 | 60 |
| 8 | >63 to <300 | 70 | 20 | 70 |
| 9 | >63 to <300 | 70 | 20 | 80 |
| 10 | >63 to <300 | 70 | 20 | 90 |
| 11 | >63 to <300 | 70 | 30 | 5 |
| 12 | >63 to <300 | 70 | 30 | 10 |
| 13 | >63 to <300 | 70 | 30 | 20 |
| 14 | >63 to <300 | 70 | 30 | 30 |
| 15 | >63 to <300 | 70 | 30 | 40 |
| 16 | >63 to <300 | 70 | 30 | 50 |
| 17 | >63 to <300 | 70 | 30 | 60 |
| 18 | >63 to <300 | 70 | 30 | 70 |
| 19 | >63 to <300 | 70 | 30 | 80 |
| 20 | >63 to <300 | 70 | 30 | 90 |
| 21 | >63 to <300 | 70 | 40 | 5 |
| 22 | >63 to <300 | 70 | 40 | 10 |
| 23 | >63 to <300 | 70 | 40 | 20 |
| 24 | >63 to <300 | 70 | 40 | 30 |
| 25 | >63 to <300 | 70 | 40 | 40 |
| 26 | >63 to <300 | 70 | 40 | 50 |
| 27 | >63 to <300 | 70 | 40 | 60 |
| 28 | >63 to <300 | 70 | 40 | 70 |
| 29 | >63 to <300 | 70 | 40 | 80 |
| 30 | >63 to <300 | 70 | 40 | 90 |
| 31 | >63 to <300 | 70 | 50 | 5 |
| 32 | >63 to <300 | 70 | 50 | 10 |
| 33 | >63 to <300 | 70 | 50 | 20 |
| 34 | >63 to <300 | 70 | 50 | 30 |
| 35 | >63 to <300 | 70 | 50 | 40 |
| 36 | >63 to <300 | 70 | 50 | 50 |
| 37 | >63 to <300 | 70 | 50 | 60 |
| 38 | >63 to <300 | 70 | 50 | 70 |
| 39 | >63 to <300 | 70 | 50 | 80 |
| 40 | >63 to <300 | 70 | 50 | 90 |
| 41 | >63 to <300 | 70 | 60 | 5 |
| 42 | >63 to <300 | 70 | 60 | 10 |
| 43 | >63 to <300 | 70 | 60 | 20 |
| 44 | >63 to <300 | 70 | 60 | 30 |
| 45 | >63 to <300 | 70 | 60 | 40 |
| 46 | >63 to <300 | 70 | 60 | 50 |
| 47 | >63 to <300 | 70 | 60 | 60 |
| 48 | >63 to <300 | 70 | 60 | 70 |
| 49 | >63 to <300 | 70 | 60 | 80 |
| 50 | >63 to <300 | 70 | 60 | 90 |
| 51 | >63 to <300 | 75 | 20 | 5 |
| 52 | >63 to <300 | 75 | 20 | 10 |
| 53 | >63 to <300 | 75 | 20 | 20 |
| 54 | >63 to <300 | 75 | 20 | 30 |
| 55 | >63 to <300 | 75 | 20 | 40 |
| 56 | >63 to <300 | 75 | 20 | 50 |
| 57 | >63 to <300 | 75 | 20 | 60 |
| 58 | >63 to <300 | 75 | 20 | 70 |
| 59 | >63 to <300 | 75 | 20 | 80 |
| 60 | >63 to <300 | 75 | 20 | 90 |
| 61 | >63 to <300 | 75 | 30 | 5 |
| 62 | >63 to <300 | 75 | 30 | 10 |
| 63 | >63 to <300 | 75 | 30 | 20 |
| 64 | >63 to <300 | 75 | 30 | 30 |
| 65 | >63 to <300 | 75 | 30 | 40 |
| 66 | >63 to <300 | 75 | 30 | 50 |
| 67 | >63 to <300 | 75 | 30 | 60 |
| 68 | >63 to <300 | 75 | 30 | 70 |
| 69 | >63 to <300 | 75 | 30 | 80 |
| 70 | >63 to <300 | 75 | 30 | 90 |
| 71 | >63 to <300 | 75 | 40 | 5 |
| 72 | >63 to <300 | 75 | 40 | 10 |
| 73 | >63 to <300 | 75 | 40 | 20 |
| 74 | >63 to <300 | 75 | 40 | 30 |
| 75 | >63 to <300 | 75 | 40 | 40 |
| 76 | >63 to <300 | 75 | 40 | 50 |
| 77 | >63 to <300 | 75 | 40 | 60 |
| 78 | >63 to <300 | 75 | 40 | 70 |
| 79 | >63 to <300 | 75 | 40 | 80 |
| 80 | >63 to <300 | 75 | 40 | 90 |
| 81 | >63 to <300 | 75 | 50 | 5 |
| 82 | >63 to <300 | 75 | 50 | 10 |
| 83 | >63 to <300 | 75 | 50 | 20 |
| 84 | >63 to <300 | 75 | 50 | 30 |
| 85 | >63 to <300 | 75 | 50 | 40 |
| 86 | >63 to <300 | 75 | 50 | 50 |
| 87 | >63 to <300 | 75 | 50 | 60 |
| 88 | >63 to <300 | 75 | 50 | 70 |
| 89 | >63 to <300 | 75 | 50 | 80 |
| 90 | >63 to <300 | 75 | 50 | 90 |
| 91 | >63 to <300 | 75 | 60 | 5 |
| 92 | >63 to <300 | 75 | 60 | 10 |
| 93 | >63 to <300 | 75 | 60 | 20 |
| 94 | >63 to <300 | 75 | 60 | 30 |
| 95 | >63 to <300 | 75 | 60 | 40 |
| 96 | >63 to <300 | 75 | 60 | 50 |
| 97 | >63 to <300 | 75 | 60 | 60 |
| 98 | >63 to <300 | 75 | 60 | 70 |
| 99 | >63 to <300 | 75 | 60 | 80 |
| 100 | >63 to <300 | 75 | 60 | 90 |
| 101 | >63 to <300 | 80 | 20 | 5 |
| 102 | >63 to <300 | 80 | 20 | 10 |
| 103 | >63 to <300 | 80 | 20 | 20 |
| 104 | >63 to <300 | 80 | 20 | 30 |
| 105 | >63 to <300 | 80 | 20 | 40 |
| 106 | >63 to <300 | 80 | 20 | 50 |
| 107 | >63 to <300 | 80 | 20 | 60 |
| 108 | >63 to <300 | 80 | 20 | 70 |
| 109 | >63 to <300 | 80 | 20 | 80 |
| 110 | >63 to <300 | 80 | 20 | 90 |
| 111 | >63 to <300 | 80 | 30 | 5 |
| 112 | >63 to <300 | 80 | 30 | 10 |
| 113 | >63 to <300 | 80 | 30 | 20 |
| 114 | >63 to <300 | 80 | 30 | 30 |
| 115 | >63 to <300 | 80 | 30 | 40 |
| 116 | >63 to <300 | 80 | 30 | 50 |
| 117 | >63 to <300 | 80 | 30 | 60 |
| 118 | >63 to <300 | 80 | 30 | 70 |
| 119 | >63 to <300 | 80 | 30 | 80 |
| 120 | >63 to <300 | 80 | 30 | 90 |
| 121 | >63 to <300 | 80 | 40 | 5 |
| 122 | >63 to <300 | 80 | 40 | 10 |
| 123 | >63 to <300 | 80 | 40 | 20 |
| 124 | >63 to <300 | 80 | 40 | 30 |
| 125 | >63 to <300 | 80 | 40 | 40 |
| 126 | >63 to <300 | 80 | 40 | 50 |
| 127 | >63 to <300 | 80 | 40 | 60 |
| 128 | >63 to <300 | 80 | 40 | 70 |
| 129 | >63 to <300 | 80 | 40 | 80 |
| 130 | >63 to <300 | 80 | 40 | 90 |
| 131 | >63 to <300 | 80 | 50 | 5 |
| 132 | >63 to <300 | 80 | 50 | 10 |
| 133 | >63 to <300 | 80 | 50 | 20 |
| 134 | >63 to <300 | 80 | 50 | 30 |
| 135 | >63 to <300 | 80 | 50 | 40 |
| 136 | >63 to <300 | 80 | 50 | 50 |
| 137 | >63 to <300 | 80 | 50 | 60 |
| 138 | >63 to <300 | 80 | 50 | 70 |
| 139 | >63 to <300 | 80 | 50 | 80 |
| 140 | >63 to <300 | 80 | 50 | 90 |
| 141 | >63 to <300 | 80 | 60 | 5 |
| 142 | >63 to <300 | 80 | 60 | 10 |
| 143 | >63 to <300 | 80 | 60 | 20 |
| 144 | >63 to <300 | 80 | 60 | 30 |
| 145 | >63 to <300 | 80 | 60 | 40 |
| 146 | >63 to <300 | 80 | 60 | 50 |
| 147 | >63 to <300 | 80 | 60 | 60 |
| 148 | >63 to <300 | 80 | 60 | 70 |
| 149 | >63 to <300 | 80 | 60 | 80 |
| 150 | >63 to <300 | 80 | 60 | 90 |
| 151 | >63 to <300 | 85 | 20 | 5 |
| 152 | >63 to <300 | 85 | 20 | 10 |
| 153 | >63 to <300 | 85 | 20 | 20 |
| 154 | >63 to <300 | 85 | 20 | 30 |
| 155 | >63 to <300 | 85 | 20 | 40 |
| 156 | >63 to <300 | 85 | 20 | 50 |
| 157 | >63 to <300 | 85 | 20 | 60 |
| 158 | >63 to <300 | 85 | 20 | 70 |
| 159 | >63 to <300 | 85 | 20 | 80 |
| 160 | >63 to <300 | 85 | 20 | 90 |
| 161 | >63 to <300 | 85 | 30 | 5 |
| 162 | >63 to <300 | 85 | 30 | 10 |
| 163 | >63 to <300 | 85 | 30 | 20 |
| 164 | >63 to <300 | 85 | 30 | 30 |
| 165 | >63 to <300 | 85 | 30 | 40 |
| 166 | >63 to <300 | 85 | 30 | 50 |
| 167 | >63 to <300 | 85 | 30 | 60 |
| 168 | >63 to <300 | 85 | 30 | 70 |
| 169 | >63 to <300 | 85 | 30 | 80 |
| 170 | >63 to <300 | 85 | 30 | 90 |
| 171 | >63 to <300 | 85 | 40 | 5 |
| 172 | >63 to <300 | 85 | 40 | 10 |
| 173 | >63 to <300 | 85 | 40 | 20 |
| 174 | >63 to <300 | 85 | 40 | 30 |
| 175 | >63 to <300 | 85 | 40 | 40 |
| 176 | >63 to <300 | 85 | 40 | 50 |
| 177 | >63 to <300 | 85 | 40 | 60 |
| 178 | >63 to <300 | 85 | 40 | 70 |
| 179 | >63 to <300 | 85 | 40 | 80 |
| 180 | >63 to <300 | 85 | 40 | 90 |
| 181 | >63 to <300 | 85 | 50 | 5 |
| 182 | >63 to <300 | 85 | 50 | 10 |
| 183 | >63 to <300 | 85 | 50 | 20 |
| 184 | >63 to <300 | 85 | 50 | 30 |
| 185 | >63 to <300 | 85 | 50 | 40 |
| 186 | >63 to <300 | 85 | 50 | 50 |
| 187 | >63 to <300 | 85 | 50 | 60 |
| 188 | >63 to <300 | 85 | 50 | 70 |
| 189 | >63 to <300 | 85 | 50 | 80 |
| 190 | >63 to <300 | 85 | 50 | 90 |
| 191 | >63 to <300 | 85 | 60 | 5 |
| 192 | >63 to <300 | 85 | 60 | 10 |
| 193 | >63 to <300 | 85 | 60 | 20 |
| 194 | >63 to <300 | 85 | 60 | 30 |
| 195 | >63 to <300 | 85 | 60 | 40 |
| 196 | >63 to <300 | 85 | 60 | 50 |
| 197 | >63 to <300 | 85 | 60 | 60 |
| 198 | >63 to <300 | 85 | 60 | 70 |
| 199 | >63 to <300 | 85 | 60 | 80 |
| 200 | >63 to <300 | 85 | 60 | 90 |
| 1a | >63 to <280 | 70 | 20 | 5 |
| 2a | >63 to <280 | 70 | 20 | 10 |
| 3a | >63 to <280 | 70 | 20 | 20 |
| 4a | >63 to <280 | 70 | 20 | 30 |
| 5a | >63 to <280 | 70 | 20 | 40 |
| 6a | >63 to <280 | 70 | 20 | 50 |
| 7a | >63 to <280 | 70 | 20 | 60 |
| 8a | >63 to <280 | 70 | 20 | 70 |
| 9a | >63 to <280 | 70 | 20 | 80 |
| 10a | >63 to <280 | 70 | 20 | 90 |
| 11a | >63 to <280 | 70 | 30 | 5 |
| 12a | >63 to <280 | 70 | 30 | 10 |
| 13a | >63 to <280 | 70 | 30 | 20 |
| 14a | >63 to <280 | 70 | 30 | 30 |
| 15a | >63 to <280 | 70 | 30 | 40 |
| 16a | >63 to <280 | 70 | 30 | 50 |
| 17a | >63 to <280 | 70 | 30 | 60 |
| 18a | >63 to <280 | 70 | 30 | 70 |
| 19a | >63 to <280 | 70 | 30 | 80 |
| 20a | >63 to <280 | 70 | 30 | 90 |
| 21a | >63 to <280 | 70 | 40 | 5 |
| 22a | >63 to <280 | 70 | 40 | 10 |
| 23a | >63 to <280 | 70 | 40 | 20 |
| 24a | >63 to <280 | 70 | 40 | 30 |
| 25a | >63 to <280 | 70 | 40 | 40 |
| 26a | >63 to <280 | 70 | 40 | 50 |
| 27a | >63 to <280 | 70 | 40 | 60 |
| 28a | >63 to <280 | 70 | 40 | 70 |
| 29a | >63 to <280 | 70 | 40 | 80 |
| 30a | >63 to <280 | 70 | 40 | 90 |
| 31a | >63 to <280 | 70 | 50 | 5 |
| 32a | >63 to <280 | 70 | 50 | 10 |
| 33a | >63 to <280 | 70 | 50 | 20 |
| 34a | >63 to <280 | 70 | 50 | 30 |
| 35a | >63 to <280 | 70 | 50 | 40 |
| 36a | >63 to <280 | 70 | 50 | 50 |
| 37a | >63 to <280 | 70 | 50 | 60 |
| 38a | >63 to <280 | 70 | 50 | 70 |
| 39a | >63 to <280 | 70 | 50 | 80 |
| 40a | >63 to <280 | 70 | 50 | 90 |
| 41a | >63 to <280 | 70 | 60 | 5 |
| 42a | >63 to <280 | 70 | 60 | 10 |
| 43a | >63 to <280 | 70 | 60 | 20 |
| 44a | >63 to <280 | 70 | 60 | 30 |
| 45a | >63 to <280 | 70 | 60 | 40 |
| 46a | >63 to <280 | 70 | 60 | 50 |
| 47a | >63 to <280 | 70 | 60 | 60 |
| 48a | >63 to <280 | 70 | 60 | 70 |
| 49a | >63 to <280 | 70 | 60 | 80 |
| 50a | >63 to <280 | 70 | 60 | 90 |
| 51a | >63 to <280 | 75 | 20 | 5 |
| 52a | >63 to <280 | 75 | 20 | 10 |
| 53a | >63 to <280 | 75 | 20 | 20 |
| 54a | >63 to <280 | 75 | 20 | 30 |
| 55a | >63 to <280 | 75 | 20 | 40 |
| 56a | >63 to <280 | 75 | 20 | 50 |
| 57a | >63 to <280 | 75 | 20 | 60 |
| 58a | >63 to <280 | 75 | 20 | 70 |
| 59a | >63 to <280 | 75 | 20 | 80 |
| 60a | >63 to <280 | 75 | 20 | 90 |
| 61a | >63 to <280 | 75 | 30 | 5 |
| 62a | >63 to <280 | 75 | 30 | 10 |
| 63a | >63 to <280 | 75 | 30 | 20 |
| 64a | >63 to <280 | 75 | 30 | 30 |
| 65a | >63 to <280 | 75 | 30 | 40 |
| 66a | >63 to <280 | 75 | 30 | 50 |
| 67a | >63 to <280 | 75 | 30 | 60 |
| 68a | >63 to <280 | 75 | 30 | 70 |
| 69a | >63 to <280 | 75 | 30 | 80 |
| 70a | >63 to <280 | 75 | 30 | 90 |
| 71a | >63 to <280 | 75 | 40 | 5 |
| 72a | >63 to <280 | 75 | 40 | 10 |
| 73a | >63 to <280 | 75 | 40 | 20 |
| 74a | >63 to <280 | 75 | 40 | 30 |
| 75a | >63 to <280 | 75 | 40 | 40 |
| 76a | >63 to <280 | 75 | 40 | 50 |
| 77a | >63 to <280 | 75 | 40 | 60 |
| 78a | >63 to <280 | 75 | 40 | 70 |
| 79a | >63 to <280 | 75 | 40 | 80 |
| 80a | >63 to <280 | 75 | 40 | 90 |
| 81a | >63 to <280 | 75 | 50 | 5 |
| 82a | >63 to <280 | 75 | 50 | 10 |
| 83a | >63 to <280 | 75 | 50 | 20 |
| 84a | >63 to <280 | 75 | 50 | 30 |
| 85a | >63 to <280 | 75 | 50 | 40 |
| 86a | >63 to <280 | 75 | 50 | 50 |
| 87a | >63 to <280 | 75 | 50 | 60 |
| 88a | >63 to <280 | 75 | 50 | 70 |
| 89a | >63 to <280 | 75 | 50 | 80 |
| 90a | >63 to <280 | 75 | 50 | 90 |
| 91a | >63 to <280 | 75 | 60 | 5 |
| 92a | >63 to <280 | 75 | 60 | 10 |
| 93a | >63 to <280 | 75 | 60 | 20 |
| 94a | >63 to <280 | 75 | 60 | 30 |
| 95a | >63 to <280 | 75 | 60 | 40 |
| 96a | >63 to <280 | 75 | 60 | 50 |
| 97a | >63 to <280 | 75 | 60 | 60 |
| 98a | >63 to <280 | 75 | 60 | 70 |
| 99a | >63 to <280 | 75 | 60 | 80 |
| 100a | >63 to <280 | 75 | 60 | 90 |
| 101a | >63 to <280 | 80 | 20 | 5 |
| 102a | >63 to <280 | 80 | 20 | 10 |
| 103a | >63 to <280 | 80 | 20 | 20 |
| 104a | >63 to <280 | 80 | 20 | 30 |
| 105a | >63 to <280 | 80 | 20 | 40 |
| 106a | >63 to <280 | 80 | 20 | 50 |
| 107a | >63 to <280 | 80 | 20 | 60 |
| 108a | >63 to <280 | 80 | 20 | 70 |
| 109a | >63 to <280 | 80 | 20 | 80 |
| 110a | >63 to <280 | 80 | 20 | 90 |
| 111a | >63 to <280 | 80 | 30 | 5 |
| 112a | >63 to <280 | 80 | 30 | 10 |
| 113a | >63 to <280 | 80 | 30 | 20 |
| 114a | >63 to <280 | 80 | 30 | 30 |
| 115a | >63 to <280 | 80 | 30 | 40 |
| 116a | >63 to <280 | 80 | 30 | 50 |
| 117a | >63 to <280 | 80 | 30 | 60 |
| 118a | >63 to <280 | 80 | 30 | 70 |
| 119a | >63 to <280 | 80 | 30 | 80 |
| 120a | >63 to <280 | 80 | 30 | 90 |
| 121a | >63 to <280 | 80 | 40 | 5 |
| 122a | >63 to <280 | 80 | 40 | 10 |
| 123a | >63 to <280 | 80 | 40 | 20 |
| 124a | >63 to <280 | 80 | 40 | 30 |
| 125a | >63 to <280 | 80 | 40 | 40 |
| 126a | >63 to <280 | 80 | 40 | 50 |
| 127a | >63 to <280 | 80 | 40 | 60 |
| 128a | >63 to <280 | 80 | 40 | 70 |
| 129a | >63 to <280 | 80 | 40 | 80 |
| 130a | >63 to <280 | 80 | 40 | 90 |
| 131a | >63 to <280 | 80 | 50 | 5 |
| 132a | >63 to <280 | 80 | 50 | 10 |
| 133a | >63 to <280 | 80 | 50 | 20 |
| 134a | >63 to <280 | 80 | 50 | 30 |
| 135a | >63 to <280 | 80 | 50 | 40 |
| 136a | >63 to <280 | 80 | 50 | 50 |
| 137a | >63 to <280 | 80 | 50 | 60 |
| 138a | >63 to <280 | 80 | 50 | 70 |
| 139a | >63 to <280 | 80 | 50 | 80 |
| 140a | >63 to <280 | 80 | 50 | 90 |
| 141a | >63 to <280 | 80 | 60 | 5 |
| 142a | >63 to <280 | 80 | 60 | 10 |
| 143a | >63 to <280 | 80 | 60 | 20 |
| 144a | >63 to <280 | 80 | 60 | 30 |
| 145a | >63 to <280 | 80 | 60 | 40 |
| 146a | >63 to <280 | 80 | 60 | 50 |
| 147a | >63 to <280 | 80 | 60 | 60 |
| 148a | >63 to <280 | 80 | 60 | 70 |
| 149a | >63 to <280 | 80 | 60 | 80 |
| 150a | >63 to <280 | 80 | 60 | 90 |
| 151a | >63 to <280 | 85 | 20 | 5 |
| 152a | >63 to <280 | 85 | 20 | 10 |
| 153a | >63 to <280 | 85 | 20 | 20 |
| 154a | >63 to <280 | 85 | 20 | 30 |
| 155a | >63 to <280 | 85 | 20 | 40 |
| 156a | >63 to <280 | 85 | 20 | 50 |
| 157a | >63 to <280 | 85 | 20 | 60 |
| 158a | >63 to <280 | 85 | 20 | 70 |
| 159a | >63 to <280 | 85 | 20 | 80 |
| 160a | >63 to <280 | 85 | 20 | 90 |
| 161a | >63 to <280 | 85 | 30 | 5 |
| 162a | >63 to <280 | 85 | 30 | 10 |
| 163a | >63 to <280 | 85 | 30 | 20 |
| 164a | >63 to <280 | 85 | 30 | 30 |
| 165a | >63 to <280 | 85 | 30 | 40 |
| 166a | >63 to <280 | 85 | 30 | 50 |
| 167a | >63 to <280 | 85 | 30 | 60 |
| 168a | >63 to <280 | 85 | 30 | 70 |
| 169a | >63 to <280 | 85 | 30 | 80 |
| 170a | >63 to <280 | 85 | 30 | 90 |
| 171a | >63 to <280 | 85 | 40 | 5 |
| 172a | >63 to <280 | 85 | 40 | 10 |
| 173a | >63 to <280 | 85 | 40 | 20 |
| 174a | >63 to <280 | 85 | 40 | 30 |
| 175a | >63 to <280 | 85 | 40 | 40 |
| 176a | >63 to <280 | 85 | 40 | 50 |
| 177a | >63 to <280 | 85 | 40 | 60 |
| 178a | >63 to <280 | 85 | 40 | 70 |
| 179a | >63 to <280 | 85 | 40 | 80 |
| 180a | >63 to <280 | 85 | 40 | 90 |
| 181a | >63 to <280 | 85 | 50 | 5 |
| 182a | >63 to <280 | 85 | 50 | 10 |
| 183a | >63 to <280 | 85 | 50 | 20 |
| 184a | >63 to <280 | 85 | 50 | 30 |
| 185a | >63 to <280 | 85 | 50 | 40 |
| 186a | >63 to <280 | 85 | 50 | 50 |
| 187a | >63 to <280 | 85 | 50 | 60 |
| 188a | >63 to <280 | 85 | 50 | 70 |
| 189a | >63 to <280 | 85 | 50 | 80 |
| 190a | >63 to <280 | 85 | 50 | 90 |
| 191a | >63 to <280 | 85 | 60 | 5 |
| 192a | >63 to <280 | 85 | 60 | 10 |
| 193a | >63 to <280 | 85 | 60 | 20 |
| 194a | >63 to <280 | 85 | 60 | 30 |
| 195a | >63 to <280 | 85 | 60 | 40 |
| 196a | >63 to <280 | 85 | 60 | 50 |
| 197a | >63 to <280 | 85 | 60 | 60 |
| 198a | >63 to <280 | 85 | 60 | 70 |
| 199a | >63 to <280 | 85 | 60 | 80 |
| 200a | >63 to <280 | 85 | 60 | 90 |

*= L-amino acid selected from the group consisting of L-lysine, L-methionine, L-threonine, L-tryptophan, L-valine
**= in particular Escherichia or Corynebacterium

### DETAILED DESCRIPTION OF THE INVENTION

L-Amino acids, such as L-lysine, L-methionine, L-threonine, L-tryptophan, L-valine, in particular L-lysine, are successfully produced by the fermentative cultivation of an amino-acid-overproducing bacterial strain. Bacteria which are used in the fermentation are preferably coryneform bacteria, in particular of the genus Corynebacterium, especially preferably the species Corynebacterium glutamicum, and/or of the genus Escherichia, especially preferably of the species Escherichia coli, by what is known as the fed-batch process. As an alternative, the fermentation may also be carried out continuously or discontinuously in the batch process or the repeated-fed-batch process, with the aim of producing L-amino acids (in particular L-lysine). The fermentation medium used is optimized for the requirements of the respective production strains. A general overview of known culturing methods is available in the textbook by Chmiel (Bioprozesstechnik 1. Einführung in die Bioverfahrenstechnik [Bioprocessing Technology 1. Introduction to Bioengineering Technology] (Gustav Fischer Verlag, Stuttgart, 1991)) or in the textbook by Storhas (Bioreaktoren and periphere Einrichtungen [Bioreactors and Peripheral Equipment] (Vieweg Verlag, Braunschweig/Wiesbaden, 1994)).

The culture medium or fermentation medium to be used must satisfy in a suitable manner the demands of the respective strains. Descriptions of culture media for various microorganisms can be found in the handbook “Manual of Methods for General Bacteriology” of the American Society for Bacteriology (Washington, D.C., USA, 1981). The expressions culture medium and fermentation medium or simply medium are mutually interchangeable.

As carbon source, use can be made of sugar and carbohydrates such as, for example, glucose, sucrose, lactose, fructose, maltose, molasses, sucrose-containing solutions from sugar beet or sugar cane production, starch, starch hydrolysate and cellulose, oils and fats, such as, for example, soybean oil, sunflower oil, peanut oil and coconut fat, fatty acids such as, for example, palmitic acid, stearic acid and linoleic acid, alcohols such as, for example, glycerol, methanol and ethanol, and organic acids such as, for example, acetic acid. These substances may be used individually or as a mixture.

As nitrogen source, use can be made of organic nitrogen-containing compounds such as peptones, yeast extract, meat extract, malt extract, cornsteep liquor, soybean meal and urea, or inorganic compounds such as ammonia, ammonium sulphate, ammonium phosphate, ammonium carbonate and ammonium nitrate, preferably ammonia or ammonium sulphate. The nitrogen sources can be used individually or as a mixture.

As phosphorus source, use can be made of phosphoric acid, potassium dihydrogenphosphate or dipotassium hydrogenphosphate or the corresponding sodium-containing salts.

The culture medium must additionally contain salts, for example in the form of sulphates of metals such as, for example, sodium, potassium, magnesium, calcium and iron, such as, for example, magnesium sulphate or iron sulphate, which are essential for growth. Finally, essential growth substances such as amino acids, for example homoserine, and vitamins, for example thiamine, biotin or pantothenic acid, can be used in addition to the abovementioned substances. In addition, suitable precursors of the respective amino acid can be added to the culture medium. These starting materials may be added to the culture in the form of a single batch or suitably fed during the culture.

For the pH control of the culture, use is made of basic compounds such as sodium hydroxide, potassium hydroxide, ammonia or ammonia water, preferably ammonia or ammonia water, or acidic compounds such as phosphoric acid or sulphuric acid in a suitable manner. The pH is generally set to a value of from 6.0 to 9.0, preferably 6.5 to 8.

To control foam development, use can be made of antifoams, such as, for example, fatty acid polyglycol esters. To maintain the stability of plasmids, suitable selectively acting substances may be added to the medium, such as, for example, antibiotics. To maintain aerobic conditions, oxygen or oxygen-containing gas mixtures such as, for example, air, are introduced into the culture. The use of liquids which are enriched with hydrogen peroxide is also possible.

If appropriate, the fermentation is run at superatmospheric pressure, for example at a pressure of from 0.03 to 0.2 MPa. The temperature of the culture is usually from 20° C. to 45° C., preferably from 25° C. to 40° C. In batch processes, the culture is continued until a maximum of the desired amino acid has formed. This target is usually attained in the course of from 10 hours to 160 hours. In continuous processes, long culture times are possible. To ferment suitably large production fermenter volumes of several hundred cubic metres, a plurality of upstream growth fermenter steps with successively increasing fermenter volumes are necessary.

Examples of suitable fermentation media are found, inter alia, in the patent specifications U.S. Pat. No. 5,770,409, U.S. Pat. No. 5,840,551 and U.S. Pat. No. 5,990,350, U.S. Pat. No. 5,275,940 or U.S. Pat. No. 4,275,157. Further examples of fermentation media are found in Ozaki and Shiio (Agricultural and Biological Chemistry 47(7), 1569-1576, 1983) and Shiio et al. (Agricultural and Biological Chemistry 48(6), 1551-1558, 1984). Methods for determining L-lysine and other L-amino acids are known from the prior art. The analysis can proceed for example as described in Spackman et al. (Analytical Chemistry, 30, (1958), 1190) by anion-exchange chromatography with subsequent ninhydrin derivatization, or it can proceed via reversed-phase HPLC as described by Lindroth et al. (Analytical Chemistry (1979) 51: 1167-1174).

The fermentation broth thus produced is subsequently processed in accordance with the invention.

A fermentation broth is considered to mean a fermentation medium in which a microorganism has been cultured for a certain time at a certain temperature. The fermentation medium or the media used during the fermentation contains/contain all substances or components which ensure the multiplication of the microorganism and production of the desired amino acid.

On completion of the fermentation, the resultant fermentation broth accordingly contains the biomass (=cell mass) of the microorganism resulting from the multiplication of the cells of the microorganism (e.g. coryneform bacterium), and the L-amino acid (in particular L-lysine) produced in the course of the fermentation, the organic by-products produced in the course of the fermentation and the components of the employed fermentation medium/media and/or of the starting materials such as, for example, vitamins such as biotin, amino acids such as homoserine or salts such as magnesium sulphate, which have not been consumed by the fermentation.

The organic by-products encompass substances which have been produced by the microorganisms employed in the fermentation, as the case may be in addition to the target product, and which may or may not have been excreted. These include other L-amino acids which, in comparison with the desired L-amino acid (in particular L-lysine), account for less than 30%, 20% or 10%. These furthermore encompass organic acids which bear one to three carboxyl groups such as, for example, acetic acid, lactic acid, citric acid, malic acid or fumaric acid. Finally, they also encompass sugars such as, for example, trehalose.

Typical fermentation broths which are suitable for industrial purposes have an L-amino acid content (in particular an L-lysine content) of from 40 g/kg to 180 g/kg or 50 g/kg to 150 g/kg. The biomass content (as dried biomass) generally amounts to from 20 to 50 g/kg in the fermentation broth.

The biomass remains completely in the fermentation broth, but some of it might also be removed from the latter. The biomass, or the biomass-containing fermentation broth, is thermally inactivated during a suitable process step. In the event that the L-amino acid is L-lysine, the fermentation broth obtained after the fermentation is acidified before concentration, preferably using sulphuric acid, and treated with sodium toulphite, which is used for stabilizing and lightening the product.

Thereafter, water is removed from the broth, and/or the broth is thickened or concentrated, using known methods such as, for example, with the aid of a rotary evaporator, a thin-film evaporator, a falling-film evaporator, by reverse osmosis or by nanofiltration. This concentrated fermentation broth is processed by spray granulation to give granules. Alternative methods to arrive at the product are freeze-drying, spray-drying or other methods such as, for example, a circulating fluidized bed. Thereafter, the resulting granules are ground to give a product of the desired particle size.

In the event that the L-amino acid is L-lysine, the resulting fermentation broth is processed in particular by carrying out a process which comprises at least the following steps:
if appropriate, measuring the ratio of sulphate to L-amino acid (in particular L-lysine),
if appropriate followed by adding ammonium sulphate and/or cornsteep liquor,
if appropriate adding sulphuric acid,
setting the pH to 4.0 to 6.5, in particular 4.9 to 5.1, by adding sulphuric acid, where, by adding the sulphate-containing compound in the previous steps, a sulphate/L-amino acid ratio of from 0.85 to 1.2, preferably 0.9 to 1.0, especially preferably >0.9 to <0.95, is established in the broth,
concentrating the fermentation broth by evaporation;
removing the water from the mixture, and drying to give granules;
adjusting the particle size to give a product which contains at least 70% by weight of particles with a particle size of from >63 μm to <300 μm, preferably >63 μm to <280 μm;
coating the particles, after the granules have been obtained and/or the particle size has been adjusted, with an edible oil to give particles which are fully or partially coated by the edible oil.

Sulphate-containing compounds in the context of the process steps mentioned hereinabove are, in particular, ammonium sulphate and/or sulphuric acid. In this manner, a product with an L-amino acid content (in particular L-lysine) of from 10 to 70% by weight (calculated as amino acid, based on the total amount) is obtained and, in the event that the L-amino acid is L-lysine, L-lysine is present in a molar sulphate/L-lysine ratio of at least 0.5, preferably 0.6, 0.8, 0.9, 0.95, 1.0, 1.05, 1.1, 1.2, more preferably from 0.85 to 1.2, preferably from 0.9 to 1.1, especially preferably from >0.95 to <1.1.

The molar sulphate/L-lysine ratio V is calculated from the formula: V=2×[SO₄²⁻]/[L-lysine].

This formula takes into account the fact that the SO₄²⁻ anion is divalent. A ratio V=1 means that a stoichiometrically composed Lys₂(SO₄) is present, while at a ratio of V=0.9 a 10% sulphate deficit is found, and at a ratio of V=1.1 a 10% sulphate excess is found.

It is possible to carry out the fermentation in the presence of such an amount of ammonium sulphate that a sulphate/L-amino acid ratio which is in the claimed range is already present when the fermentation is complete. If appropriate, measuring the L-amino acid/sulphate ratio may be dispensed with in such a case. If appropriate, further addition of ammonium sulphate is no longer necessary, either.

If acid is added beyond the lowering of the pH in accordance with the invention, increased amounts of acid are required due to the buffer effect of the compounds present in the broth, and such increased amounts of acid may subsequently result in the undesired denaturation and disruption of the cells of the coryneform bacteria.

In a process variant according to the invention, one or more of the salts of sulphurous acid (sulphites) selected from the group ammonium, alkali metal and alkaline-earth metal salt are added to the fermentation broth in an amount of from 0.01 to 0.5% by weight, preferably from 0.1 to 0.3% by weight, especially preferably from 0.1 to 0.2% by weight, based on the fermentation broth. It is preferred to employ alkali metal hydrogen sulphite and especially preferred to employ sodium hydrogen sulphite.

The sulphites, in particular sodium hydrogen sulphite, are preferably added in the form of a solution before the fermentation broth is concentrated. The amount employed is preferably taken into account when adjusting the sulphate/L-amino acid ratio.

Procedures which are preferred in the process according to the invention for the production of L-amino-acids- (in particular L-lysine-) containing feed additives are those which give products which contain components of the fermentation broth.

At least part of the biomass, preferably all of the biomass, is left in the fermentation broth. If appropriate, the biomass, or the biomass-containing fermentation broth, is inactivated during a suitable process step.

In a preferred procedure, none of, or only small amounts of, the biomass is/are removed, so that all (100%) or more than 70%, 80%, 90%, 95%, 99% or 99.9% of the biomass remains in the generated product.

Before being concentrated, the resulting fermentation broth is preferably acidified with sulphuric acid and, if appropriate, treated with ammonium sulphate. Finally, the broth may also be stabilized by adding, preferably, sodium toulphite (sodium hydrogen sulphite) or another salt, for example ammonium, alkali metal or alkaline-earth metal salt of sulphurous acid.

The organic by-products which are dissolved in the fermentation broth and the unconsumed components of the fermentation medium (starting materials) which are dissolved remain at least in part (>0%), preferably at at least 25%, especially preferably at at least 50% and very especially preferably at at least 75% in the product. If appropriate, they also remain completely (100%) or almost completely, in other words >95% or >98%, in the product. In this sense, the expression “fermentation-broth-based” means that a product contains at least some of the components of the fermentation broth.

Thereafter, water is removed from the broth, or the broth is thickened or concentrated, with the aid of known methods such as heating or raising the temperature for example by means of a rotary evaporator, a thin-film evaporator or a falling-film evaporator, or by reverse osmosis or nanofiltration. This concentrated broth can subsequently be processed by methods of freeze-drying, of spray-drying, of spray granulation or by other processes, such as for example in a circulating fluidized bed as described in WO 2005/006875, to give free-flowing finely particulate or coarsely particulate products, in particular granules. If appropriate, the granules obtained are subjected to screening or dust removal to isolate the product in the desired particle size.

It is also possible to obtain a finely-particulate powder or a coarsely-particulate product directly, i.e. without previously concentrating the fermentation broth treated in accordance with the invention by means of spray-drying or spray granulation.

The free-flowable, finely particulate powder, in turn, can be converted by suitable compacting or granulation methods to give a coarsely-particulate, storable and largely dust-free product with good flowability.

The granules can be prepared for example by the processes as specified in EP-B 0 615 693 or EP-B 0 809 940, U.S. Pat. No. 5,840,358 or WO 2005/006875 or WO 2004/054381.

“Free-flowing” is taken to mean powders which flow unimpeded out of a series of glass outlet vessels having differently sized outlet openings, at least from the vessel having the 5 mm (millimetres) opening (Klein: Seifen, Öle, Fette, Wachse 94, 12 (1968)).

Preferred products are those with a fraction of from ≧70, 75, 80, 90, 95, 97% by weight of a particle size of from >63 μm to <300 μm or a fraction of from ≧70, 75, 80, 85, 90, 95, 97% by weight of a particle size of from >63 to <280 μm or a fraction of from ≧70, 75, 80, 85, 90, 95, 97% by weight of a particle size of from >100 to <300 μm in diameter. The dust content, i.e. the fraction of particles with a particle size of <63 μm, is preferably 25% by weight or less, 15% by weight or less, 10% by weight or less, 5% by weight or less, 3% by weight or less, 2% by weight, 0 to 1% by weight, 0.5% by weight or less.

The bulk density of the preferred products amounts generally to from 500 to 650 kg/m³.

It is advantageous in the granulation or compacting to make use of customary organic or inorganic auxiliaries or supports such as starch, gelatin, cellulose derivatives or similar materials, as are customarily used in food or feed processing by way of binder, gelling agent or thickener, or other substances such as, for example, silicas, silicates (EP-A 0 743 016) or stearates.

In addition it is advantageous to provide the surface of the resulting granules with oils as described in WO 04/054381. Oils which can be used are vegetable oils or mixtures of vegetable oils. Examples of such oils are soybean oil, olive oil, soybean oil/lecithin mixtures. Treatment of the surfaces with these oils achieves an increased abrasion resistance of the product and a decrease of the dust fraction. The oil content in the product is from 0.02 to 2.0% by weight, preferably from 0.02 to 1.0% by weight and very especially preferably from 0.2 to 1.0% by weight, based on the total amount of the feed additive.

Alternatively, however, the product may also be taken up onto one of the organic or inorganic carriers which are known and conventionally used in feed processing, such as, for example, silicas, silicates, meals, including coarse meals, brans, starches, sugars or others, and/or mixed and stabilized with conventionally used thickeners or binders. Use examples and processes in this context are described in the literature (Die Mühle+Mischfuttertechnik 132 (1995) 49, page 817).

Finally, the product may also be improved by means of coating processes using film-forming agents such as, for example, metal carbonates, silicas, silicates, alginates, stearates, starches, rubbers and cellulose ethers, as described in DE-C 41 00 920.

To adjust a desired concentration of L-amino acid in the product, depending on requirements during the process, the L-amino acid may be added in the form of a concentrate or, if appropriate, an essentially pure substance or salt thereof in liquid or solid form. These can be added individually or as mixtures to the as-obtained or concentrated fermentation broth, or else during the drying or granulation process. The solid products produced by the process according to the invention are preferably granules and have, inter alia, the following properties:

In the embodiment in which the L-amino acid is L-lysine, they have a pH of from 3.5 to 6.5, in particular from 4.0 to 5.0, preferably from 4.2 to 4.8, measured in aqueous suspension. To measure the pH, a 10% by weight strength suspension in deionized water is prepared, and the pH is measured at 25° C. using a pH electrode. The reading is constant after approximately 1 minute.

They have an L-amino acid content (in particular an L-lysine content, calculated as lysine base) of from 10% by weight to 70% by weight, preferably from 30 to 60% by weight or from 30 to 65% by weight and very especially preferably from 40% by weight to 60% by weight or from 40% by weight to 65% by weight, based on the total amount of product.

In general, the water content is between 0.1% by weight and not more than 5% by weight. The water content preferably amounts to not more than 4% by weight, especially preferably to not more than 3% by weight and very especially preferably to not more than 2.5% by weight. Water contents of not more than 2% by weight are likewise possible.

### DESCRIPTION OF THE FIGURES

FIG. 1: Saving in the production costs of aquafeeds when using lysine from the product according to the invention (lysine sulphate) instead of lysine-HCl.

FIG. 2: Coefficient of variation as characteristic of the homogeneity in mixtures of identical aquaculture feed compositions when using L-lysine from different origins (products and manufacturers are mentioned in the table hereinbelow).

| | | | L-Lysine |
|---|---|---|---|
| | | | content (%), |
| Sample | Product name | Manufacturer | minimum |
| Lys from product | | Evonik | 50.7 |
| according to invention | | | |
| Product A | Lysine HCl | Ajinomoto | 78.8 |
| Product B | Lysine Plus | Cheil Jedang | 51 |
| Product C | Protein Lysin | Global Biochem | 51 |

FIG. 3: Particle size distribution of the product of the described production method without addition of soybean oil as coating agent.

The diagram shows the cumulative frequency distribution (Q3(x)) and the density distribution (q3(x)) from the particle size analysis. The cumulative frequency distribution curve Q3(x) indicates the standardized amount of all particles with an equivalent diameter equaling or less than x: (Q3(xi)=mi/m). The density distribution q3(x) is the quotient from the fraction Q3 of the particles in an equivalent diameter interval and the difference, of the upper and lower limit of the equivalent diameter interval, which goes with it, or else the first derivative of the cumulative frequency distribution curve Q3(x). q3(x)=dQ3(x)/dx.

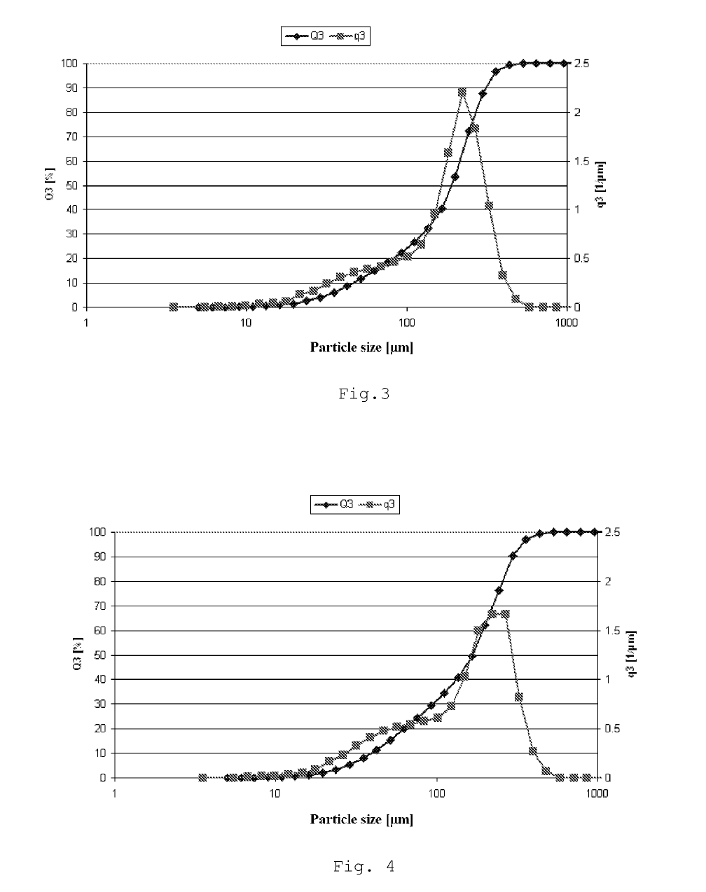

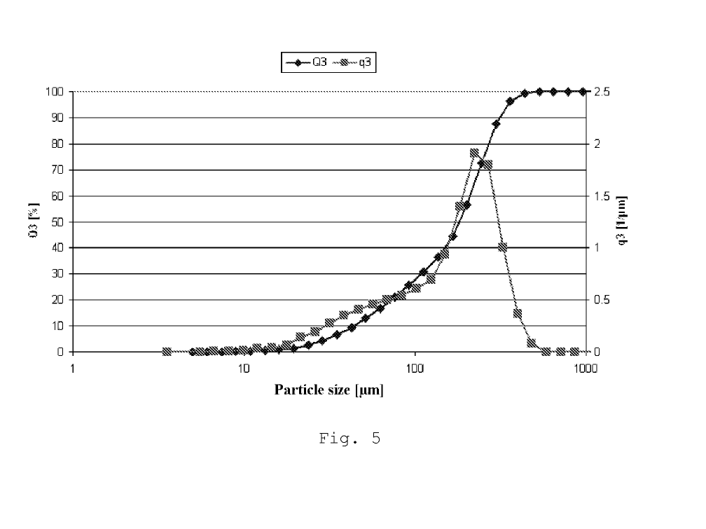

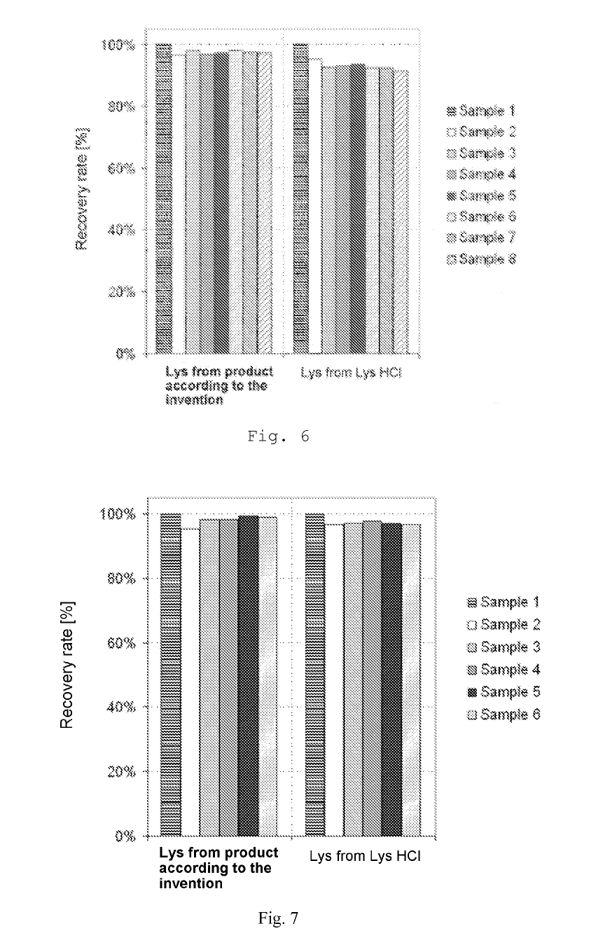

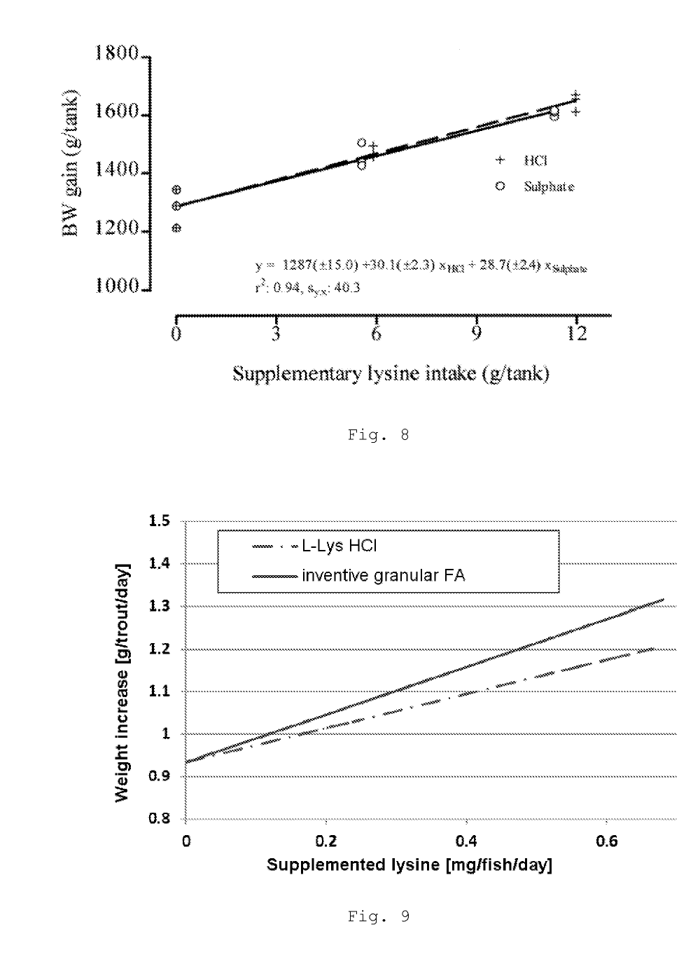

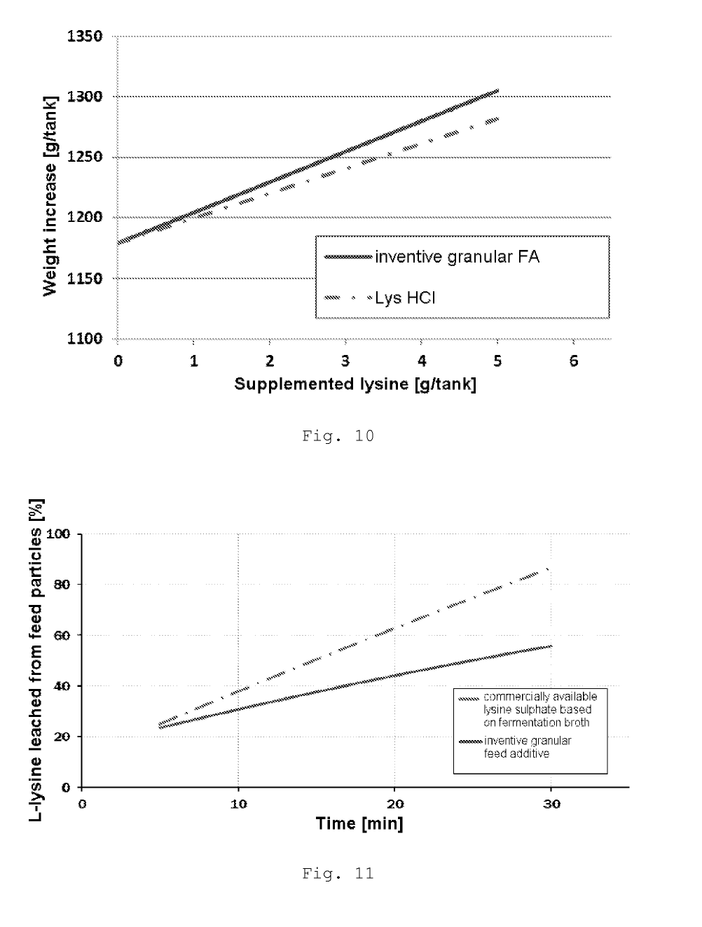

FIG. 4: Particle size distribution of the product of the described production method with addition of 0.22% soybean oil as coating agent (definition of Q3 and q3 as per FIG. 3).

FIG. 5: Particle size distribution of the product of the described production method with addition of 0.44% soybean oil as coating agent (definition of Q3 and q3 as per FIG. 3).

FIG. 6: Recovery rate for L-lysine in the experiments with improved hydrothermal stability during the feed production process by extrusion.

FIG. 7: Recovery rate for L-lysine in the experiments with improved hydrothermal stability during the feed production process by pelleting.

FIG. 8: comparison of commercially available fermentation-broth-based lysine sulphate with lysine HCl in feed blends in relation to the weight increase of fed trout.

FIG. 9: growth effect in feeding trials with rainbow trout with different levels of lysine supplementation from inventive granular feed additive (FA) or lysine HCl as lysine source.

FIG. 10: growth effect in feeding trials with rainbow trout with different amounts of lysine from inventive granular feed additive (FA) or lysine HCl as lysine source.

FIG. 11: leaching behavior of inventive granular feed additive and commercially available lysine sulphate based on fermentation broth in extruded fish feed (test duration 30 min at 30 ppt salinity).

The present invention is illustrated in greater detail by the examples which follow, without these examples imposing any limitation whatsoever on the invention.

### EXAMPLE 1

### Fermentation and Granulation

A fermentation vessel equipped with stirrer and aerating system was charged with 150 kg of a sterile solution of the following composition:

TABLE 1.1

| Constituent | Amount | |
|---|---|---|
| Water | 130 | l |
| Glucose | 12.4 | kg |
| Maize gluten | 9.0 | kg |
| hydrolysate, sulphuric | | |
| Ammonium sulphate | 1.5 | kg |
| Mineral salts, | 0.4 | kg |
| trace elements | | |

| | |
|---|---|
| pH (adjusted with | 7.5 |
| ammonia solution) | |

This solution was treated, at 33 to 35° C., with 12 l of an inoculum of an L-lysine-producing Corynebacterium which had been grown in the same fermentation medium, but in a separate fermentation vessel. Within 40 hours, 77 l of a sterile solution which, before being neutralized to pH 7.5, had the following composition:

TABLE 1.2

| Constituent | Amount | |
|---|---|---|
| Water | 38 | l |
| Glucose | 40.0 | g |
| Maize gluten | 8.3 | kg |
| hydrolysate, sulphuric | | |
| Ammonium sulphate | 0.9 | kg |
| Antifoam (Nalco ®) | 0.08 | kg |
| Mineral salts, | 0.2 | kg |
| trace elements | | |

During the entire fermentation period, the pH was maintained at between 7.0 and 7.5, using ammonia solution. The stirrer speed was set to 600 rpm and the aeration rate to 0.5 to 0.7 vvm.

At the end of the fermentation period, 275 kg of a crude fermentation broth with a solids content of 34.1 kg, an L-lysine base content of 15.5 kg and a sugar content of 0.71 kg was obtained. The microorganisms were destroyed by heat.

The sulphate/L-lysine ratio V in the fermentation broth was increased to approximately 0.90 (based on dry matter) by adding ammonium sulphate via a 37 percent solution. Thereafter, the pH was adjusted to approximately 5.1 by adding concentrated sulphuric acid. As the result, the sulphate/L-lysine ratio V increased to approximately 0.92 (based on dry matter). Owing to the dilution effect, the L-lysine content in the dry matter dropped to a value of 55.4% by weight.

Thereafter, the fermentation broth was heated to approximately 60° C., concentrated in vacuo and finally granulated.

The fermentation concentrate obtained had a water content of approximately 53%, an L-lysine base content of approximately 24%, a sugar content of approximately 1%, a biomass content of approximately 10%, the remainder being other fermentation by-products and minerals.

### EXAMPLE 2

### Granulation of the Concentrated Fermentation Product

A fluidized-bed granulation dry unit, equipped with a gas distributor plate of diameter approx. 400 mm and two-blade fan of diameter 150 mm, integrated into the fluidized bed, was charged with 30 kg of granules as the initial charge. The fan was operated at a circumferential speed of 20 m/s. The fluidized bed was charged with hot air of approximately 210° C. as drying and fluidizing agent, and the concentrate of the lysine fermentation of Example 1 was injected continuously via a two-substance nozzle at approximately 60 kg/h. After approximately 4 to 5 hours, a stationary operating state was reached, and granules with the following product parameters were discharged continuously.

The product properties of granules obtained in a steady-state procedure are compiled in Table 2.1.

TABLE 2.1

| | |
|---|---|
| Moisture | 3% |
| Bulk density | 690 kg/m³ |
| Tamped density | 710 kg/m³ |
| Particle size distribution | 10% by wt. <900 μm |
| | 50% by wt. <1200 μm |
| | 90% by wt. <1550 μm |
| Abrasion | 0.2% |
| Erweka friability tester, | |
| 50 g, 20 min, 20 rpm, 400-μm | |
| screen | |
| Particle breaking strength | 2.5-7N |

The L-lysine content in the product obtained amounted to 52.7% by weight. The residual water content in the product amounted to approximately 2% by weight. Thus, the lysine loss amounted to approximately 2.4% by weight.

The biomass content amounted to 10% by weight.

### EXAMPLE 3

### Adjustment of the Particle Size

To adjust the particle size of the granules obtained in Example 2, 200 kg of the granules were placed into a roll-type crusher from Merz Aufbereitungstechnik, type Kleinmahlanlage WPB 2/3. The unit was equipped with a feeding funnel, vibroconveyor and a discharge tube.

For the grinding, the milling gap was set at 0.2 to 0.3 mm. The rollers employed were used rollers, so that the milling gap in the central zone of the roller was 0.3 mm and in the outer zones of the roller 0.2 mm. The differential speed of the rollers was set at 0.5, which means that one roller rotated at twice the speed of its counter roller. The rollers employed had a smooth surface without profile. The feed rate was set at 65 kg/h and the roller speed at 8 m/s (roller No. 1) and 2 m/s (roller No. 2).

The granules obtained were checked for their particle size (Example 4).

### EXAMPLE 4

### Determination of the Particle Size Distribution (Screen Analysis)

Determination of the particle size distribution of ground substances was carried out with the aid of a screen analysis which is favourable in terms of fluid dynamics. Here, the material was moved exclusively by a stream of air, whereby particle abrasion was avoided as much as possible. The entire particle size range was determined successively by using a set of different screens with different screen mesh sizes.

The air-jet screening machine used was a Hosokawa Alpine, type 200 LS-N, with matching screen set (V₂A type). The screen sets used had mesh sizes of 20, 32, 45, 63, 100, 150, 200, 250, 280, 300, 400, 500, 600, 630, 710, 800, 1000, 1180, 1400, 1600 and 2000 μm (DIN ISO 3310).

In the air-jet screening machine, the product on the screen is lifted up by the stream of air, the nozzle going round in a circle and blowing through the screen. The pot of the apparatus includes a suction element through which the fine product which falls through the screen is sucked away.

The antistatic added in accordance with the sample weight was 0.5% Alumina C (Degussa-Hüls, now Evonik). Alumina C is amorphous and also goes through the smallest screen used in this experiment, which has a mesh size of 20 μm.

### Experimental Procedure

25 g of the material to be analysed were weighed and placed on the screen with the finest screen mesh size. The screen with the sample was introduced into the screening machine, the lid was closed, and screening was subsequently carried out for 3 minutes. The remainder was weighed and transferred quantitatively to the screen with the next screen mesh size, using a brush.

Thereafter, the process steps were repeated.

Electrostatic charging of the sample was avoided by adding 0.5% by weight of Alumina C (Degussa-Hüls, now Evonik), based on the respective remaining sample weight. AluminaC is amorphous and even passes through the screen with the smallest mesh size of 20 μm. After 2-3 revolutions of the nozzle, the product is discharged.

### Calculation

The screen analysis describes the percentage of the individual screen fractions based on the initial amount (25 g=100%).

The percentage proportion per screen fraction is calculated as follows:

Fraction=undersize (g)×100/W (g) [%]

W=initial sample weight

(For calculating the residue, the amount of added antistatic is negligible).

The granules obtained from Example 3 were checked in respect of the particle size, and the results shown in Table 4.1 were obtained.

TABLE 4.1

| | |
|---|---|
| Bulk density | 550 kg/m³ |
| Particle size distribution | 13% by wt. <63 μm |
| | 50% by wt. <200 μm |
| | 90% by wt. <300 μm |

The particle size distribution is additionally illustrated in FIG. 3. The biomass content amounted to 10% by weight.

### EXAMPLE 5

### Coating of the Particles with Oil

To coat the granules obtained from Example 3 with oil, the granules were placed into a Ruberg mixer type HM 50. The oil used was a soybean oil which is commercially available from food stores. The soybean oil was injected into the mixer via a conical hollow nozzle (type 121, 1.2 mm, spray cone 90°, from Düsen-Schlick GmbH) with a relative pressure of 400 000 Pa, using nitrogen, and mixed at 75 rpm. Different experiments were carried out using different amounts of soybean oil. The amount of soybean oil based on the granules was 0.22 or 0.44% by weight.

Checking the particle size distribution of the product obtained gave the results shown in Table 5.1.

TABLE 5.1
Granules coated with soybean oil (0.22%)

| | |
|---|---|
| Bulk density | 578 kg/m³ |
| Particle size distribution | 16% by wt. <63 μm |
| | 62% by wt. <200 μm |
| | 90% by wt. <300 μm |

Granules coated with soybean oil (0.44%)

| | |
|---|---|
| Bulk density | 572 kg/m³ |
| Particle size distribution | 13% by wt. <63 μm |
| | 56% by wt. <200 μm |
| | 88% by wt. <300 μm |

The particle size distribution of the granules is also shown in FIG. 4 (granules coated with soybean oil: 0.22%) and FIG. 5 (granules coated with soybean oil: 0.44%).

### EXAMPLE 6

### Dust Formation During the Grinding Process

Grinding the granules of Example 2 was carried out as described in Example 3, a ventilation additionally being installed so as to collect the dust fraction at the outflow of the mill. For the purposes of the present invention, the dust fraction is defined as particles with a particle size of <63 μm. After screening, this fraction was determined by gravimetry. It was found that the dust fraction of the product obtained in accordance with Example 2 amounted to 7.5%.

A number of methods are available for the “dust test” for defining or determining the dust. Frequently, dust is defined as a particle fraction of <63 μm, and this definition is based on a gravimetric test. Examples of gravimetric test apparatuses are the “Heubach test” or dust determination by the “Groschopp” method. These test apparatuses provide extensive data on the dust, both in terms of quantity and of quality.

### EXAMPLE 7

### Advantageous Properties of the Granules Containing Lysine Sulphate in Contrast to Lysine HCl

In the past, the lysine source used for feed was lysine HCl, which is highly purified by ion-exchanger steps.

In the present experiment, the granules contain L-lysine in the form of L-lysine sulphate, which is obtained directly by fermentative production without biomass removal, followed by concentration and drying (by spray granulation or spray-drying). 74% by weight of the granules have a particle size distribution of from >63 to <300 μm.

FIG. 1 shows the cost advantage in US dollars per tonne of feed when using the granules according to the present invention in comparison with the use of lysine HCl in the production of salmon and prawn/shrimp feed.

### EXAMPLE 8

### Improved Miscibility of the Granules

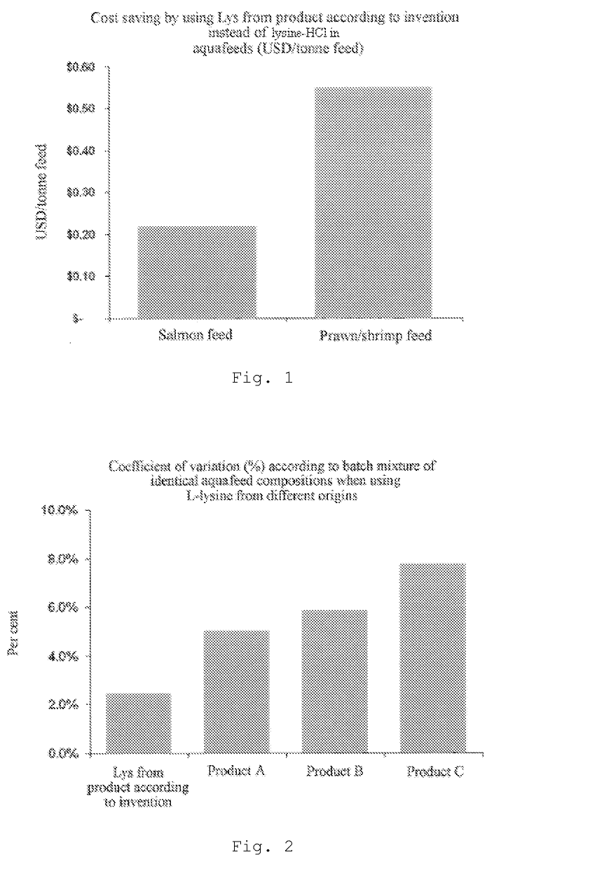

Owing to their particle size distribution, the distribution, in the finished feed, of lysine-containing feed additives which are commercially available on the market is worse, the reason being that the amount employed in relation to the finished feed is small. Owing to the fact that according to the invention at least 70% by weight of the particles have a particle size diameter of from >63 μm to <300 μm, a markedly better statistical distribution of the lysine in the finished feed was found. FIG. 2 shows the coefficient of variation for the granules of the present invention in comparison with granules of the prior art containing lysine sulphate (products B and C) or lysine HCl (product A). In product A, 68% by weight of the particles had a particle size diameter of from 500 μm to 1180 μm (80% by weight having a particle size diameter of from 300 μm to 1180 μm). In product B, 94% by weight of the particles had a particle size diameter of from 710 μm to 1400 μm. In product C, 91% by weight of the particles had a particle size diameter of greater than 710 μm (75% by weight having a particle size diameter of 710 μm to 1400 μm).

### Experimental Procedure

The homogeneous distribution of feed in a compound feed batch was tested in what is known as a “mixer profile test”, and this also served to check the mixer properties. The “coefficient of variation” (CV) was used to describe the uniformity/homogeneity of a feed blend. The CV (in %) is the ratio of the standard deviation (SD) and the mean of the characterizing value (for example the concentration of the added feed additive), multiplied by 100. The CV is influenced predominantly by the physical and chemical properties of each component. The smaller the “coefficient of variation (CV)”, the better the homogeneity.

The apparatuses used for carrying out the experiments are a balance, a mixer (for example single-screw belt screw mixer), a sampling device and suitable analytical apparatuses for determining the test feed additive in the final feed.

The compound feed is placed into the mixer without addition of the feed additive. Thereafter, the test addition of the feed additive in question is added, the optimal fill volume being 75-90% of the mixer volume.

The mixing time in the belt screw mixer was 4 min. 8 to 10 samples were taken at the outflow of the mixer.

The following formula was used for the calculation:

$$C V [ \% ] = \frac{S D \times 100}{mean}$$

SD=standard deviation

mean=mean of the analytical results of all analysed samples

The following applies to assessing the commercial quality of a compound feed:

CVₘᵢₓ<5% excellent homogeneity, small analytical deviation

CVₘᵢₓ 5-10% acceptable homogeneity and analytical deviation

CVₘᵢₓ>10% poor homogeneity and/or large analytical deviation

### Measurement of the Homogeneity:

It was particularly important to ensure that the 10 samples were representative of the complete variation in the mixture. Sampling errors cannot be corrected at a later stage in the analytical laboratory. Sampling at the mixer outlet therefore had to be carried out at regular intervals over the entire discharge period. A sample size of 100-200 g per sample was sufficient. One extraction and amino acid analysis per sample (amino acid analyser or HPLC analysis) was carried out in the laboratory. To eliminate a further source of error, the dry matter content was determined. The analytical results were compiled in a table which indicates the individual reading, the mean, the standard deviation and the coefficient of variation for each supplemented amino acid.

### EXAMPLE 9

### Improved Hydrothermal Stability

During the processing of supplemented feed blends to feed pellets in established production processes, high thermal and mechanical stresses act on the supplemented feed additives when moisture is present. The result of this stress, which is known as hydrothermal stress, may be that the additives are damaged to some extent.

So as to be able to assess what is known as the hydrothermal stability of the additives, and to compare them with each other, the production processes for producing pelleted and extruded aquafeed was reproduced on a small scale. In each case two feed blends which differ only in respect of the L-lysine additive were employed, mixture A being supplemented with 0.50% granular feed additive according to the present invention and mixture B with 0.32% Lys×HCl, which corresponded in each case to identical lysine base concentrations. The granular feed additive according to the invention contained 50.7% by weight of lysine in the form of lysine sulphate and 10% by weight of biomass. 74% by weight of the granular feed additive according to the invention had a particle size distribution of from >63 to <300 μm.

The process parameters, such as, for example, residence time, temperature or water content, were set at values which are typically used in practice. During the experiments, samples of the feed blend were taken after the respective individual process steps and subjected to extensive amino acid analysis. The hydrothermal stabilities of the test additives upon processing in the processes in question can be assessed relative to one another via the recovery rates.

### Test Feed Blends

The feed blends corresponded to representative state-of-the-art formulas. The materials employed were mostly plant-based feed components such as, for example, soybean meal or wheat meal, but also, to a small extent, fish meal. The individual feeds were initially ground to a particle size of <1 mm in a hammer mill, weighed individually and then mixed for 5 minutes in a mixer. The feed blend was premixed and bagged. The composition of the feed blends A and B is shown in Table 9.1.

TABLE 9.1

| Feed component | Mixture A | Mixture B |
|---|---|---|
| Fish meal | 25.0% | 25.0% |
| Extracted soybean meal | 31.4% | 31.4% |
| Extracted rapeseed meal | 7.5% | 7.5% |
| Soybean oil | 3.0% | 3.0% |
| Fish oil | 1.5% | 1.5% |
| Wheat bran shorts | 25.5% | 25.5% |
| Dicalcium phosphate 22 | 4.3% | 4.3% |
| Premix | 2.3% | 2.5% |
| Granular feed additive | 0.50% | — |
| according to the | | |
| invention | | |
| Lys × HCl | — | 0.32% |

### Experimental Procedure

### Experiment 9.1: Extruded Aquafeed

The hydrothermal stability of the granules according to the present invention was compared with the hydrothermal stability of Lys×HCl. The hydrothermal stability of the additives for extruded shrimp/prawn feed was examined and assessed during the entire respective process. To this end, the process was divided into individual process steps and reproduced on a small scale.

In each case two virtually identical feed mixers were employed, with mixture A being supplemented with 0.50% granular feed additive according to the invention (composition as described in Example 9) and mixture B being supplemented with 0.32% Lys×HCl (see table).

In the case of the extruded prawn/shrimp feed, the individual process steps are preconditioning, shaping (extrusion), drying of the product and, ultimately, cooling of the product.

During the production process, several feed samples were taken. Sample 1 was taken from the ground, premixed and supplemented feed blend. Sample 2 was dispensed after leaving the preconditioning unit. Sample 3 was dispensed directly after the extrusion. Sample 4 was dispensed after the drying, and sample 5 after cooling of the product.

In the process, the process parameters such as, for example, residence time, temperature or water content were set at typical values used in practice. Table 9.2 hereinbelow shows a schematic summary of the production process and of the samplings.

TABLE 9.2

| | Residence | Temperature | | Water content | |
|---|---|---|---|---|---|
| Process step | time | Mixture A | Mixture B | Mixture A | Mixture B |

(Sample 1: Unprocessed feed blend)

| | | | | | |
|---|---|---|---|---|---|
| Pre- | 2 min. | 80° C. | 80° C. | 27.9% | 28.7% |
| conditioning | | | | | |

(Sample 2: Preconditioned feed blend)

| | | | | | |
|---|---|---|---|---|---|
| Extrusion | 10 sec. | 87° C. | 88° C. | 26.2% | 27.2% |

(Sample 3: Extrudates)

| | | | | | |
|---|---|---|---|---|---|
| Drying | 15 min. | 70° C. | 70° C. | 8.0% | 5.0% |

(Sample 4: Dried extrudates)

| | | | | | |
|---|---|---|---|---|---|
| Cooling | 3 min. | 22° C. | 22° C. | 7.2% | 4.4% |

(Sample 5: Cooled extrudates = final product)

The following equipment was used:
Pre-conditioner (equipment: Lödige mixer with electrical wall heating and steam connection (2 bar), capacity: 100 l)
Extruder (type: single-shaft extruder, Amandus-Kahl, type OEE 8, shaft diameter: 80 mm, driving motor: 11 kW
Drying unit (drying chamber with screen tray, vertical hot-air flow)
Cooling unit (drying chamber with screen tray, vertical cold-air flow)

### Experiment 9.2: Pelleted Aquafeed

To assess the hydrothermal stabilities of the test additives according to the invention and of Lys×HCl, the aquafeed pelleting process was divided into individual process steps and reproduced on a small scale. In each case two almost identical feed blends were employed, mixture A being supplemented with 0.50% of Lys product according to the invention and mixture B with 0.32% Lys×HCl.

The individual process steps in pelleted shrimp/prawn feed are pre-conditioning, shaping (pelleting), post-conditioning, drying and finally cooling of the product.

During the production process, several samples of the feed were taken. Sample 1 was taken from the ground, premixed and supplemented feed blend. Sample 2 was dispensed after leaving the pre-conditioner. Sample 3 was dispensed directly after pelleting. Sample 4 was taken after post-conditioning. Sample 5 was dispensed after drying, and sample 6 after cooling of the product.

In the process, the process parameters such as, for example, residence time, temperature or water content were set at typical values used in practice. Table 9.3 hereinbelow shows a schematic summary of the production process and of the samplings.

TABLE 9.3

| | Residence | Temperature | | Water content | |
|---|---|---|---|---|---|
| Process step | time | Mixture A | Mixture B | Mixture A | Mixture B |

(Sample 1: Unprocessed feed blend)

| | | | | | |
|---|---|---|---|---|---|
| Pre- | 6 min. | 80° C. | 80° C. | 17.8% | 16.6% |
| conditioning | | | | | |

(Sample 2: Preconditioned feed blend)

| | | | | | |
|---|---|---|---|---|---|
| Pelleting | 10 sec. | 68° C. | 68° C. | 16.3% | 15.3% |

(Sample 3: Feed pellets)

| | | | | | |
|---|---|---|---|---|---|
| Post- | 15 min. | 65° C. | 65° C. | 16.3% | 15.3% |
| conditioning | | | | | |

(Sample 4: Heat-treated feed pellets)

| | | | | | |
|---|---|---|---|---|---|
| Drying | 15 min. | 70° C. | 70° C. | 4.7% | 5.9% |

(Sample 5: Dried pellets)

| | | | | | |
|---|---|---|---|---|---|
| Cooling | 3 min. | 22° C. | 7.2° C. | 4.2% | 4.7% |

(Sample 6: Cooled pellets = final product)

The following equipment was used
Pre-conditioner (equipment: Lödige mixer with electrical wall heating and steam connection (2 bar), capacity: 100 l)
Press (flat-die press, Amandus-Kahl, type 14-175, die diameter: 175 mm, piston width: 29 mm, driving motor: 3 kW)
Post-conditioner (jacketed insulation vessel with lid)
Drying unit (drying chamber with screen tray, vertical hot-air flow)
Cooling unit (drying chamber with screen tray, vertical cold-air flow)

### Analysis

### Dry Matter

A representative sample of the feed blend or the feed pellets was ground and subsequently dried for 4 hours at 103° C.

### Amino Acids

In the amino acid determination, the supplemented amino acid lysine was determined. The ground feed sample was extracted with a dilute hydrochloric acid which contained norleucin as the internal standard at room temperature, with stirring. Protein hydrolysis does not take place under these extraction conditions. After the filtrate had been treated with citrate buffer (pH=2.20), the mixture was separated by liquid chromatography on an amino acid analyser (ion exchanger, sulphonated polystyrene). The individual amino acids obtained in the separation were subsequently derived with ninhydrin within the unit (post-column derivatization). Thereafter, the amino acids were subjected to photometric quantitation at 570 nm. The following coefficients of variation (CV) were used for the amino acid determinations:

CV (lysine): 2.67%

By analysing the feed samples which had been taken at different points of the production process, the recovery rates and thus the stabilities of the test feed additives in the production process were examined and compared with each other.

TABLE 9.4

| | | Mixture A | | Mixture B | |
|---|---|---|---|---|---|
| | | | Lysine | | Lysine |
| | | Lysine | content | Lysine | content |
| | | content | rel. | content | rel. |
| | Sample | abs. | (sample | abs. | (sample |
| Experiment | No. | in g/kg | 1 = 100%) | in g/kg | 1 = 100%) |
| 1 | 1 | 2.59 | 100.0% | 2.66 | 100.0% |
| | 2 | 2.50 | 96.6% | 2.53 | 95.4% |
| | 3 | 2.54 | 98.3% | 2.46 | 92.7% |
| | 4 | 2.51 | 96.9% | 2.47 | 93.0% |
| | 5 | 2.52 | 97.3% | 2.49 | 93.7% |
| 2 | 1 | 2.59 | 100.0% | 2.66 | 100.0% |
| | 2 | 2.46 | 95.2% | 2.57 | 96.7% |
| | 3 | 2.54 | 98.3% | 2.58 | 97.0% |
| | 4 | 2.54 | 98.3% | 2.60 | 97.7% |
| | 5 | 2.57 | 99.3% | 2.58 | 97.0% |
| | 6 | 2.56 | 99.0% | 2.57 | 96.7% |

Comparison of the Granules According to the Present Invention with the Competitor Product Lys×HCl

A comparison of the granules according to the present invention with the competitor product Lys×HCl when used in a fish feed, with production by extrusion or by pelleting being tested, revealed a markedly better hydrothermal stability of the lysine of the granules according to the present invention, which is present in the form of lysine sulphate, than lysine from Lys HCl during the process samples.

The results are compiled in the figures and in Table 9.4. FIG. 6 shows the results of the lysine contents by extrusion. FIG. 7 shows the results of the lysine contents by pelleting.

It was found that, when processed in the same shrimp/prawn feed production process, the lysine from the granules according to the present invention, which is in the form of lysine sulphate, is more stable than the lysine in the competitor's granules (prior art), in which lysine is present as lysine HCl. 2.7% of the lysine from the granules according to the present invention was lost during the processing to give shrimp/prawn feed. In comparison, it emerged that the lysine from the lysine source lysine HCl was markedly more unstable, with 8.6% being lost.

When employing the pelleting method as the production process—pelleting as such being a more gentle process than extrusion—the results again revealed a markedly higher thermal stability of the lysine from the granules according to the present invention (approximately 1% loss upon pelleting) in comparison with the lysine from the lysine source lysine HCl (approximately 3.3% loss).

### EXAMPLE 10

### Comparison of Commercially Available Lysine Sulphate Based on Fermentation Broth Versus Commercially Available Lysine HCl

The published literature reports no difference of commercially available lysine sulphate based on fermentation broth in comparison with lysine HCl as lysine source in fish feed (source: “Availability and utilization of free lysine in rainbow trout (Oncorhynchus mykiss) 2. Comparison of L-lysine HCl and L-lysine sulphate”); M. Rodehutscord et al.; Aquaculture 187; 2000; 177-183).

In this study, feeding trials were carried out with rainbow trout, with different amounts of lysine in the aquafeed being set using granular, commercially available lysine sulphate, based on fermentation broth, or granular, commercially available lysine HCl as lysine sources. The particle size distributions for both products were such that more than 80% by weight of the particles had a size >300 μm (lysine HCl more than 86% by weight >200 μm, more than 81% by weight >300 μm, and, for the commercially available lysine sulphate based on fermentation, more than 92% by weight >250 μm, more than 74% by weight >500 μm).

The aquafeed contained the composition stated in the tables below.

TABLE 10.1
base medium

| Feed component | Mixture A |
|---|---|
| Wheat gluten | 65% |
| Fish oil | 10% |
| Sunflower oil | 2.5% |
| Bovine tallow | 2.5% |
| Inorganic binders | 4.0% |
| Minerals and vitamins | 6.5% |
| TiO₂ | 1.0% |
| L-lysine HCl | 0.1% |

TABLE 10.2
composition of the feed blend for the feeding trial of rainbow trout

| Ingredients | L-lysine supplemented as | | | | |
|---|---|---|---|---|---|
| (g/kg) | — | HCl | Sulphate | HCl | Sulphate |
| Base medium | 916 | 916 | 916 | 916 | 916 |
| Wheat starch, | 74 | 74 | 71 | 74 | 68 |
| gelatinized | | | | | |
| L-Alanine | 10 | 5 | 5 | — | — |
| L-Lysine HCl | — | 5 | — | 10 | — |
| (78% L- | | | | | |
| lysine) | | | | | |
| L-Lysine | — | — | 8 | — | 16 |
| sulphate | | | | | |
| (commercially | | | | | |
| available | | | | | |
| lysine | | | | | |
| sulphate | | | | | |
| based on | | | | | |
| fermentation | | | | | |
| broth, 46.8% | | | | | |
| L-lysine) | | | | | |
| Calculated | 9.0 | 12.8 | 12.6 | 16.7 | 16.4 |
| lysine | | | | | |
| concentration | | | | | |
| (g/kg DM) | | | | | |

The aquafeed in the base blend contained in the blend a crude protein fraction of 55% and a lysine fraction of 0.9%.

As is evident from FIG. 8, there was a significant increase in the weight of the trout as the lysine concentration of the tested feed went up.

However, the nature of the lysine source (lysine sulphate or lysine HCl had no effect on the weight increase. Based on this analysis, the availability of the two lysine sources may be considered to be the same.

### EXAMPLE 11

### Comparison of Inventive Granular Feed Additive and Lysine HCl in Growth Trials with Rainbow Trout

The effect on the growth behavior of fish through the inventive granular feed additive was compared against lysine HCl as lysine source.

### Experiment 11.1 Inventive Granular Feed Additive Versus Lysine HCl

In a first study, feeding trials were carried out with rainbow trout, the lysine supplementation in the aquafeed being achieved in one case through inventive granular feed additive and in the other case through lysine HCl.

In the inventive granular feed additive, the biomass content amounted to 10% by weight, the lysine present was in the form of the sulphate salt, and the particles were coated with 0.22% by weight of soybean oil.

The particle size distribution of the inventive feed additive used was 78% by weight >63 μm, 63% by weight >100 μm, 44% by weight >150 μm, 20% by weight >200 μm and 3% by weight >300 μm.

The particle size distribution of the commercially available lysine HCl used was 96% by weight >63 μm, 94% by weight >100 μm, 91% by weight >150 μm, 87% by weight >200 μm, 82% by weight >300 μm, 70% by weight >500 μm, 38% by weight >710 μm and 1% by weight >1180 μm.

The aquafeed contained the composition identified in the table below:

TABLE 11.1

| Feed component | Blend A |
|---|---|
| Corn gluten | 49% |
| Wheat flour | 27% |
| Fish meal | 10% |
| Rapeseed oil | 11% |

Minerals and vitamins

| | |
|---|---|
| Lysine addition | See below |

The aquafeed contained in the base composition a crude protein fraction of 40.6% and a protein-bound lysine fraction of 1.2%. In addition, the amount of lysine was boosted and included additionally 0, 0.3, 0.6 or 0.9% L-lysine from Lys HCl, or inventive granular feed corresponding to the amount of lysine.

The studies were carried out in 360 l tanks each containing 30 trout, and the feeding trial took place over 84 days.

### Results

FIG. 9 shows the growth effect in feeding trials with rainbow trout for different levels of lysine supplementation from inventive granular feed additive or lysine HCl as lysine source. The broken line shows the growth effect for commercially available lysine HCl as described above, while the continuous line shows the growth effect for inventive granular feed additive as described above.

An increase in the amount of lysine in the aquafeed leads to an improved average daily weight increase. For a given level of lysine supplementation, however, in all of the concentration ranges tested, the inventive feed additive leads to a higher weight increase than commercially available L-lysine HCl. The advantage of the inventive granular feed additive as a lysine source in comparison with lysine HCl is clearly evident. This points to a higher nutritional value of the inventive granular feed additive in comparison to lysine HCl under the trial conditions.

Taking account of the results shown in example 10, the greater weight increases in aquafeed application that were achieved in the feeding trials shown above are attributable to the inventively claimed particle size distribution and not to any possible differences in the availability of lysine HCl relative to lysine sulphate. As shown in example 10, with an approximately equal particle size distribution, there is no difference between granular feed additive containing lysine sulphate and granular feed additive containing lysine HCl.

### Experiment 11.2 Inventive Granular Feed Additive Versus Lysine HCl

In a second study series, feeding trials were again carried out with rainbow trout. They followed the pattern of experiment 11.1 with different amounts of lysine added. The lysine sources employed are the same as in experiment 11.1.

The aquafeed contained the composition identified in the table below.

TABLE 11.2

| Feed component | Blend A |
|---|---|
| Wheat gluten | 20% |
| Fish meal | 14% |
| Soybean meal | 9% |
| Soybean protein concentrate | 6% |
| Corn gluten | 3% |
| Corn starch | 10% |
| Wheat semolina bran | 9% |
| Fish oil | 12% |
| Rapeseed oil | 6% |

Minerals and vitamins

| | |
|---|---|
| Lysine addition | See below |

The aquafeed contained in the base composition a crude protein fraction of 39.5% and a protein-bound lysine fraction of 1.6%. The lysine amount was additionally boosted and included additionally 0, 0.1, 0.2, 0.4 or 0.6% L-lysine from Lys HCl, or inventive granular feed additive corresponding to the amount of lysine. The particle size distributions for the inventive granular feed additive and for the commercially available lysine HCl correspond to the figures given in experiment 11.1 “inventive granular feed additive versus lysine HCl”.

The feeding trial took place for the duration of 84 days.

### Results

FIG. 10 shows the growth effect in feeding trials with rainbow trout for different quantities of lysine from inventive granular feed additive or lysine HCl as lysine source, using the base medium shown in Table 11.2. The broken line shows the growth effect for commercially available lysine HCl as described above; the continuous line shows the growth effect for inventive granular feed additive as described above.

As in experiment 11.1, these studies concern the higher weight increase of the fish in the feeding trial when inventive granular feed additive is used as lysine source in comparison to lysine HCl as lysine source.

An increase in the amount of lysine in the aquafeed leads to an improved average daily weight increase. For a given level of lysine supplementation, in all of the concentration ranges tested, the inventive feed additive leads to a higher weight increase than commercially available L-lysine HCl. Clearly evident again is the advantage of the inventive granular feed additive as lysine source, in comparison to lysine HCl.

### EXAMPLE 12

### Comparison of the Leaching Properties of Commercially Available Lysine Sulphate Based on Fermentation Broth Versus Inventive Granular Feed Additive

The inventive granular feed additive, with a bulk density of 610 kg/m3 and a particle size distribution of 78% by weight >63 μm, 63% by weight >100 μm, 44% by weight >150 μm, 20% by weight >200 μm and 3% by weight >300 μm, was studied for use in the aquaculture sector, in terms of leaching behavior, and was compared with the more coarsely particulate commercially available lysine sulphate based on fermentation broth.

In the inventive granular feed additive, the biomass content amounted to 10% by weight, the lysine present took the form of the sulphate salt, and the particles were coated with 0.22% by weight of soybean oil.

The product specification of the commercially available, fermentation-broth-based lysine sulphate was as follows: bulk density 650 kg/m3+/−10%, biomass content 11% by weight, particles coated with 0.22% by weight of soybean oil, particle size distribution min. 90% by weight 300-1600 μm.

The additives for this example were mixed into a fish diet typically used for finfish such as carp or rainbow trout, with a 0.5% supplementation rate. The feed sample was subsequently extruded with a single-screw extruder. The leaching behavior of the additives was investigated over a typical residence duration of 30 minutes.

### Experimental Procedure

5.00 g of the sink feed were placed in a 250 mL beaker with a screw-top lid, in 100 g of distilled water with a salinity of 30 ppt, and shaken in an incubator at a rate of 100 revolutions/minute at room temperature. A sample was taken at a defined point in time, and the lysine concentration was determined by means of HPLC. The concentration of lysine in each vessel corresponds to the leached amount of lysine.

TABLE 12.1
feed composition

| Identification | Proportion [%] | [kg] |
|---|---|---|
| Wheat, fine | 9.95 | 398.00 |
| Rinse charge, wheat | 0.50 | 19.90 |
| Corn, fine | 46.68 | 1876.26 |
| Wheat gluten Milurex | 4.58 | 183.08 |
| Fine shredded | 28.86 | 1154.20 |
| soybean, 48 grade | | |
| Vegetable fat L20 | 4.48 | 179.10 |
| Carbonic acid lime, | 1.76 | 70.18 |
| fine | | |
| Monocalc./cefkaph. | 1.39 | 55.59 |
| Cattle salt | 0.12 | 4.78 |
| Premix | 0.48 | 19.17 |
| Soda/sodium | 0.12 | 4.64 |
| carbonate | | |
| Supplemented amino | 0.60 | 24.11 |
| acids | | |
| Commercially | 0.50 | 20.00 |
| available, | | |
| fermentation-broth- | | |
| based lysine | | |
| sulphate or | | |
| inventive granular | | |
| feed additive | | |
| | 100 | 4000 |

### Parameters

Diameter of extrudates: 4 mm

Length of extrudates: d10=5.7 mm; d50=7.1 mm; d90=8.8 mm Average w/l ratio of extrudates=0.58

The results from example 12 are shown in FIG. 11. FIG. 11 shows the leaching behavior of inventive granular feed additive and commercially available, fermentation broth-based lysine sulphate in extruded fish feed (test duration 30 min at 30 ppt salinity). The broken line shows the profile of the leaching behavior for commercially available, fermentation-broth-based lysine sulphate over time; the continuous line shows the leaching behavior for inventive granular feed additive as described above, over time.

The results of example 12 as shown in FIG. 11 illustrate how the finely particulate inventive granular feed additive leaches more slowly from the extrudates than the more coarsely particulate commercially available fermentation-broth-based lysine sulphate.

Commercially available lysine sulphate exhibits greater leaching, which also means that feed particles containing these L-lysine-containing additives also become depleted in lysine more quickly, this lysine consequently being no longer available to the target organisms (aquatic organisms).

On account of its improved leaching properties, the inventive granular feed additive is especially suitable as a source of L-lysine in the aquaculture sector.

What is claimed is:

1. A granular fermentation-broth-based feed additive, comprising an L-amino acid selected from the group consisting of: L-lysine, L-methionine, L-threonine, L-tryptophan, and L-valine, or mixtures thereof, suitable for the preparation of feeds for animals kept in aquaculture, and wherein:
a) the content of said L-amino acid or mixture of L-amino acids comprises ≧20% by weight of the total weight of the feed additive;
b) the feed additive comprises particles and at least 70% by weight of said particles have a particle diameter of from >63 μm to <300 μm;
c) the feed additive has a biomass content of ≧5% by weight and
d) the surface of the particles in said granular feed additive is fully or partially coated with an edible oil.

2. The feed additive of claim 1 wherein said L-amino acid is L-lysine present as a sulphate salt and wherein the molar ratio of sulphate to L-lysine is at least 0.5.

3. The feed additive of claim 1, comprising biomass derived from the genus Corynebacterium or the genus Escherichia.

4. The feed additive of claim 1, wherein the content of said L-amino acid or mixture of L-amino acids is ≧30% by weight of the total weight of the feed additive.

5. The feed additive of claim 1, wherein the content of said L-amino acid or mixture of L-amino acids is ≧60% by weight of the total weight of the feed additive.

6. The feed additive claim 1 wherein at least 75% by weight of the particles have a particle size diameter of from >63 μm to <300 μm.

7. The feed additive claim 1 wherein at least 75% by weight of the particles have a particle size diameter of from >63 μm to <280 μm.

8. The feed additive of claim 1, comprising a biomass content of ≧10% by weight.

9. The feed additive of claim 1, comprising a biomass content of ≧50% by weight.

10. The feed additive of claim 1, comprising a biomass content of ≧80% by weight.

11. The feed additive of claim 1, wherein the edible oil is selected from the group consisting of: a vegetable oil, an animal oil or fat, or an oil produced fermentatively by a microorganism.

12. The feed additive of claim 1, wherein the edible oil is a vegetable oil selected from the group consisting of: soybean oil, olive oil, and sunflower seed oil.

13. The feed additive of claim 1, wherein the edible oil accounts for 0.01 to 2% by weight of the total feed additive composition.

14. The feed additive of claim 1, wherein at least 70% by weight of the particles have a particle size diameter of from >63 μm to <300 μm, with the particle size distribution being measured by screening analysis in a Hosokawa Alpine air-jet screening apparatus, type 200 LS-N, screening set: mesh sizes 20, 32, 45, 63, 100, 150, 200, 250, 280, 300, 400, 500, 600, 630, 710, 800, 1000, 1180, 1400, 1600 and 2000 μm; using a screening time of 3 minutes.

15. The feed additive of claim 3 wherein said L-amino acid is L-lysine present as a sulphate salt and wherein the molar ratio of sulphate to L-lysine is at least 0.5.

16. The feed additive of claim 15, wherein:
a) at least 75% by weight of the particles have a particle size diameter of from >63 μm to <280 μm; and
b) the content of said L-amino acid is ≧60% by weight of the total weight of the feed additive.

17. The feed additive of claim 16, wherein:
a) said feed additive comprises a biomass content of ≧80% by weight;
b) the edible oil in said feed additive is selected from vegetable oil, animal oil or fat, or oil produced fermentatively by microorganisms; and
c) the edible oil accounts for 0.01 to 2% by weight of the total feed additive composition.

18. A process for the preparation of the feed additive of claim 1, comprising the steps:
a) fermenting an L-amino-acid-producing microorganism in an aqueous nutrient medium under aerobic conditions, wherein said L-amino acid is selected from the group consisting of L-lysine, L-methionine, L-threonine, L-tryptophan, and L-valine;
b) concentrating the fermentation broth by evaporation;
c) in the event that the L-amino acid is L-lysine: adding of ammonium sulphate and/or sulphuric acid, wherein a sulphate/L-amino acid ratio of from 0.85 to 1.2 in the broth is established;
d) removing water from the mixture and drying to give granules;
e) adjusting particle size to give a product which contains at least 70% by weight of particles with a particle size of from >63 μm to <300 μm; and
f) coating the particles of step d) and/or e) with an edible oil to give particles which are fully or partially coated by the edible oil.

19. A feed for animals kept in aquaculture, comprising the additive of claim 1.
